(19) United States
(12) Patent Application Publication
(10) Pub. No.: US 2026/0120349 A1
(43) Pub. Date: Apr. 30, 2026

(54) GENERATING COLORING PAGES UTILIZING GENERATIVE MODELS

(71) Applicant: Adobe Inc., San Jose, CA (US)

(72) Inventors: Apoorva ., Noida (IN); Aastha Sharma, Laxmi Nagar (IN); Abhishek Garg, Rohini (IN); Deep Sinha, Greater Noida (IN); Navodit Mandal, Noida (IN); Rohit Kumar Guglani, Noida (IN); Shruti Pachaury, Delhi (IN); Tapan Agarwal, Meerut (IN)

(21) Appl. No.: 18/930,222

(22) Filed: Oct. 29, 2024

(51) Int. Cl. G06T 11/20; G06T 5/70; G06T 11/00; G06T 11/40

(52) U.S. Cl. CPC G06T 11/23; G06T 5/70; G06T 11/10; G06T 11/40

(57) ABSTRACT

The present disclosure is directed toward systems, methods, and non-transitory computer readable media that generate a preliminary coloring page portraying elements from a text prompt utilizing a generation diffusion model and refine the preliminary coloring page to generate a coloring page. In particular, the disclosed systems receive, via an interaction with a user device, a text prompt specifying elements to portray within a coloring page. Furthermore, the disclosed systems generate an image generation prompt from the text prompt. Moreover, the disclosed systems utilize the generation diffusion model to generate a preliminary coloring page depicting the elements from the text prompt. In addition, the disclosed systems refine the preliminary coloring page to generate the coloring page.

### BACKGROUND

Advancements in computing devices and digital content design systems have led to innovative developments in image design and generation. Current digital content design applications are able to interpret the text-based inputs, such as sentences or keywords, to generate visual designs. In some cases, the existing design applications generate fully rendered, colored images with a high level of detail. For example, some digital content design applications are capable of transforming text descriptions into photo-realistic images. However, despite these advances, existing image generation systems have a number of shortcomings with regard to flexibility, efficiency, and accuracy.

### SUMMARY

One or more embodiments provide benefits and/or solve one or more of the foregoing or other problems in the art with systems, methods, and non-transitory computer readable storage media that generate an on-demand digital coloring page from a text prompt utilizing a combination of a media generation diffusion model and an image refinement model. Utilizing prompt engineering, the disclosed systems generate an image generation prompt to cause the image generation diffusion model to generate a preliminary coloring page portraying elements with the characteristics of a coloring page. In some cases, the disclosed systems generate the image generation prompt based on the text prompt, a reference image, and prompt keywords. In one or more embodiments, the disclosed systems utilize an image refinement model to refine the preliminary coloring page and generate a coloring page by generating a two-tone image from the preliminary coloring page, removing excess details based on a detail threshold, and applying anti-aliasing to enhance the outlines. Furthermore, in some embodiments, the disclosed systems generate a colored preview of the coloring page based on colors from the color palette selected a color palette. In some embodiments, the disclosed systems provide the coloring page utilizing a specialized user interface which facilitates coloring inside fillable areas delineated by the continuous outlines of the coloring page.

### BRIEF DESCRIPTION OF THE DRAWINGS

This disclosure will describe one or more example embodiments of the systems and methods with additional specificity and detail by referencing the accompanying figures. The following paragraphs briefly describe those figures, in which:

FIG. 1 illustrates a schematic diagram of an example environment of a coloring page generation system in accordance with one or more embodiments;

FIG. 2 illustrates an example overview of generating a coloring page from a text prompt utilizing a media generation diffusion model and an image refinement model in accordance with one or more embodiments;

FIG. 3 illustrates an example of generating an image generation prompt in accordance with one or more embodiments;

FIG. 4 illustrates an example of a guided diffusion model in accordance with one or more embodiments;

FIG. 5 illustrates an example of a U-Net in accordance with one or more embodiments;

FIG. 6 illustrates an example of a method for conditional media generation in accordance with one or more embodiments;

FIG. 7 illustrates an example of a diffusion process in accordance with one or more embodiments;

FIG. 8 illustrates a flow diagram depicting an algorithm as a step-by-step procedure for training a machine-learning model in accordance with one or more embodiments;

FIG. 9 illustrates an example of a method for training a diffusion model in accordance with one or more embodiments;

FIG. 10A illustrates an example of generating a two-tone image from a preliminary coloring page in accordance with one or more embodiments;

FIG. 10B illustrates an example of generating a cleaned image from a two-tone image in accordance with one or more embodiments;

FIG. 10C illustrates an example of generating a coloring page from a cleaned image in accordance with one or more embodiments;

FIG. 11 illustrates an example of generating a preview image for a coloring page in accordance with one or more embodiments;

FIGS. 12A-12D illustrate examples of utilizing a graphical user interface to generate coloring pages utilizing the coloring page generation system in accordance with one or more embodiments;

FIG. 13 illustrates a diagram of an example architecture of the coloring page generation system in accordance with one or more embodiments;

FIG. 14 illustrates a flowchart of a series of acts for generating a coloring page from a text prompt in accordance with one or more embodiments;

FIG. 15 illustrates an example of an image generation system apparatus in accordance with one or more embodiments; and

FIG. 16 illustrates a block diagram of an example computing device in accordance with one or more embodiments.

### DETAILED DESCRIPTION

This disclosure describes one or more embodiments of a coloring page generation system that generates an on-demand digital coloring page from a text prompt utilizing a combination of a media generation diffusion model and an image refinement model to generate a digital coloring page suitable for coloring. For example, the coloring page generation system generates an image generation prompt based on the text prompt and a reference image to cause a media generation diffusion model to generate a preliminary image portraying elements with the characteristics of a coloring page. In one or more embodiments, the coloring page generation system utilizes an image refinement model to refine the preliminary coloring page and generates a coloring page by generating a two-tone image from the preliminary coloring page, removing excess details based on a detail threshold, and applying anti-aliasing to enhance the outlines. Furthermore, in some embodiments, the coloring page generation system selects a color palette and generates a colored preview of the coloring page. In some embodiments, the coloring page generation system provides a user interface for filling the coloring page with colors from the color palette, drawing along the edges of elements, and/or controlling strokes to stay within the designated outlines of the coloring page.

More specifically, in one or more embodiments, the coloring page generation system generates an image generation prompt from a basic text prompt designed to prompt a media generation diffusion model to generate a preliminary coloring page with qualities and characteristics appropriate for an image in a coloring book. The coloring page generation system uses the image generation prompt as an input to the media generation diffusion model, in combination with a reference image, to generate a preliminary coloring page. For example, the coloring page generation system constructs the image generation prompt by combining the text prompt, a reference image, and prompt keywords to generate the preliminary coloring page by replicating visual characteristics from the reference image. In some embodiments, the coloring page generation system constructs the image generation prompt to prompt the media generation diffusion model to generate a preliminary coloring page as an image with continuous outlines with fillable regions portraying elements from the text prompt based on the style of the reference image.

As mentioned, in certain embodiments, the coloring page generation system utilizes a media generation diffusion model to generate a preliminary coloring page. For example, the coloring page generation system utilizes a guided diffusion model as the media generation diffusion model, where the guided diffusion model is trained to generate new data based on a reference image and the image generation prompt. In some embodiments, the media generation diffusion model works iteratively by adding noise to the data during a forward process and learning to recover the data by denoising the data during a reverse process to generate the preliminary coloring page.

In one or more embodiments, the coloring page generation system utilizes an image refinement model to refine the preliminary coloring page and generate the coloring page. For example, the coloring page generation system generates a two-tone image from the preliminary coloring page. In some cases, the coloring page generation system detects the edges and the background of the preliminary coloring page to generate continuous outlines of the two-tone image. In some embodiments, the coloring page generation system generates the continuous outlines based on dark regions of the preliminary coloring page and fillable regions based on light regions of the preliminary coloring page. In some cases, the coloring page generation system utilizes a luma threshold to determine the light regions and the dark regions within the preliminary coloring page to generate the tow-tone image.

In certain embodiments, the coloring page generation system utilizes the image refinement model to refine the two-tone image to generate a cleaned image. For example, the coloring page generation system discards pixels in narrow fillable regions or very narrow borders. In some cases, the coloring page generation system determines median color values for pixels within the two-tone image based on the colors of adjacent pixels. Furthermore, the coloring page generation system assigns a median color values to pixels of the two-tone image. In this way, the coloring page generation system discards (or converts) pixels in regions that do not satisfy a median color value for a threshold width (e.g., a diameter of 5 pixels).

In one or more embodiments, the coloring page generation system utilizes the image refinement model to further refine the cleaned image using anti-aliasing techniques. In particular, the coloring page generation system introduces intermediate shades along the edges of the continuous outlines within the two-tone image. For example, instead of maintaining a hard transition from a black object to a white background, the coloring page generation system utilizes anti-aliasing to create a gradient of gray pixels at the edges of the outlines. In some embodiments, the coloring page generation system adjusts the intensity or transparency of the pixels at the edges of the outlines based on how much of the pixel is part of the object to make the transition between the object and the background less abrupt. In this way, the coloring page generation system generates a coloring page with crisp, clear outlines that are free of jagged edges.

In certain embodiments, the coloring page generation system provides the coloring page to a user device. In one or more embodiments, the coloring page generation system provides the coloring page to a user device through an interactive application, such as a paint-inside application. For example, the coloring page generation system provides an interface for users to easily fill predefined areas (such as sections in a coloring page) with color. For example, the coloring page generation system provides tools to automatically fill outlined regions with color based on a single click, ensuring accurate coloring within designated boundaries. For example, the coloring page generation system provides stroke control features to ensure that freehand strokes or brush actions stay within the specified boundaries. When a user draws or shades within a region, the coloring page generation system prevents the strokes from crossing the outline, keeping the color within the defined outlines.

Relatedly, the coloring page generation system generates a colored preview image for display on the user device. As an example, the coloring page generation system determines a color palette for the coloring page and fills the fillable regions of the coloring pages with colors from the color palette. In some cases, the coloring page generation system determines the color palette from the preliminary coloring page. In some cases, the coloring page generation system determines the color palette from a color palette API. In this way, the coloring page generation system provides a reference image (e.g., the preview image) on the user device denoting example colors for the coloring page.

As mentioned, the coloring page generation system overcomes inherent shortcomings of existing design systems, particularly in terms of flexibility, accuracy, and operational efficiency when generating coloring pages from text prompts. For example, many existing design systems lack the precision necessary to generate appropriately formatted coloring pages directly from a text prompt. Instead, current design systems produce fully rendered images that contain intricate textures and a high level of detail, which are not suitable for use as coloring pages. For example, coloring pages require bold, clean outlines that clearly separate fillable regions, yet current design systems lack the ability to distill complex images into clear, structured line drawings with continuous outlines. Indeed, in part because current design systems do not incorporate features such as a reference image or keywords specifically tailored to create high-quality coloring page templates, current design systems must rely on external tools to refine their outputs into images suitable for use as coloring pages.

Moreover, the deficiencies of current design systems lead to operational inefficiencies. In particular, while some current design systems can provide detailed images based on input text, these systems fail to generate high-quality coloring page templates. For example, current design systems focus on high-quality artistic output, without incorporating specialized post-processing to simplify output images for coloring. Indeed, with current design systems, user devices require additional tools or manual editing to transform an output image into a format suitable for coloring. Consequently, current design systems often require multiple device interactions, have complicated workflows, and involve application swapping when generating an on-demand coloring page.

Furthermore, existing design systems are inflexible when creating, customizing, and interacting with coloring pages. Most design systems are designed to produce fully rendered images or offer pre-made templates, lacking the ability to generate on-demand coloring pages from a text prompt. Moreover, these design systems do not support options for generating coloring pages in specific styles using reference images or keywords. In addition, current design systems are inflexible when integrating coloring page design with coloring capabilities. For example, current design systems lack the ability to integrate coloring page generation with advanced drawing features such as color previews and precise drawing tools, further reducing their versatility.

Embodiments of the coloring page generation system overcome these disadvantages of existing design systems. For example, the coloring page generation system significantly improves accuracy over current design systems by generating coloring pages that incorporate continuous outlines without excess visual clutter. Unlike existing systems that produce highly detailed, fully rendered images, this coloring page generation system can automatically simplify complex imagery into bold, clean outlines that are suitable for coloring pages. By integrating features like reference images and prompt keywords, the coloring page generation system creates accurate outlines for coloring pages in a simplified, stylized format. By utilizing features like edge detection, detail clearing, and anti-aliasing the coloring page generation system reduces visual noise, eliminating tiny, hard-to-fill regions or stray pixels while creating crips, smooth outlines.

Relatedly, the coloring page generation system is operationally efficient, eliminating the need for manual post-processing or additional tools to simplify the generated coloring pages. By incorporating specialized post-processing such as automated edge detection and detail cleaning directly into the coloring page generation workflow, the coloring page generation system generates on-demand coloring pages that are ready for use. Indeed, unlike current design systems which require switching between multiple applications to generate a ready-to-use coloring page, the coloring page generation system can generate a completed coloring page directly from a text prompt. The streamlined process of the coloring page generation system significantly reduces the number of required device interactions for the creation of on-demand coloring pages, enabling user devices to generate high-quality, simplified coloring pages in an operationally efficient manner.

The coloring page generation system also provides a high degree of flexibility, providing user devices with a range of options for creating, customizing, and interacting with coloring pages. For example, the coloring page generation system generates on-demand coloring pages from text prompts and applies specific styles through the use of reference images and/or prompt keywords. Unlike the pre-made templates of some existing systems, the coloring page generation system generates on-demand coloring pages that vary in complexity, style, and content. In some embodiments, the coloring page generation system seamlessly integrates with drawing applications, providing features such as color previews and precise drawing tools (e.g., color filling, stroke control) to interact with the coloring page within a unified workflow.

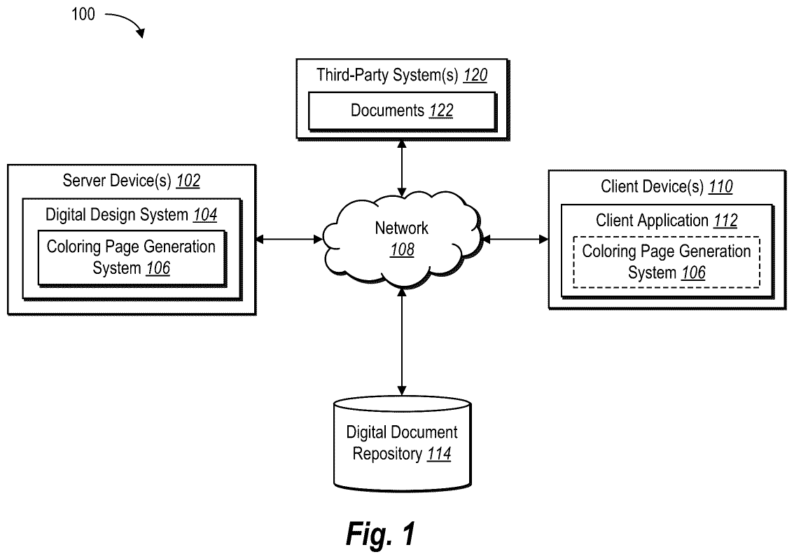

Additional detail regarding the coloring page generation system will now be provided with reference to the figures. For example, FIG. 1 illustrates a schematic diagram of an exemplary system environment (e.g., environment 100) in which a coloring page generation system 106 operates. As illustrated in FIG. 1, the environment 100 includes server device(s) 102, a network 108, client device(s) 110, and third-party system(s) 120.

Although the environment 100 of FIG. 1 is depicted as having a particular number of components, the environment 100 is capable of having any number of additional or alternative components (e.g., any number of servers, client devices, or other components in communication with the coloring page generation system 106 via the network 108. Similarly, although FIG. 1 illustrates a particular arrangement of the server device(s) 102, the network 108, client device(s) 110, digital document repository 114, and third-party system(s) 120, various additional arrangements are possible.

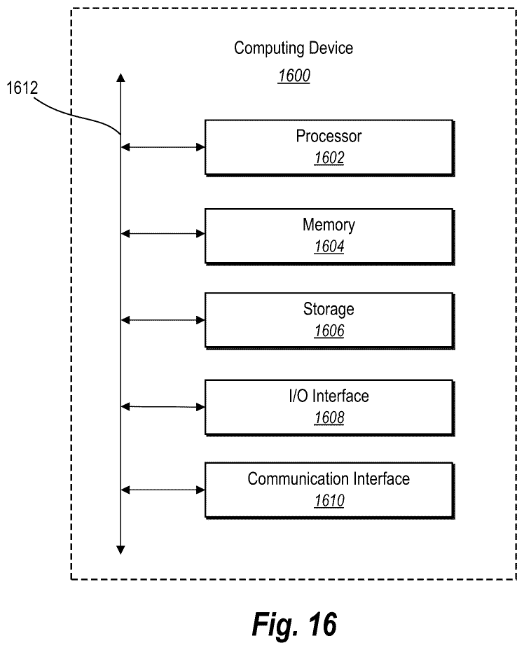

The server device(s) 102, the network 108, client device(s) 110, digital document repository 114, and third-party system(s) 120 are communicatively coupled with each other either directly or indirectly (e.g., through the network 108 discussed in greater detail below in relation to FIG. 16). Moreover, the server device(s) 102 and client device(s) 110 include one of a variety of computing devices (including one or more computing devices as discussed in greater detail with relation to FIG. 16).

As illustrated in FIG. 1, the environment 100 includes the server device(s) 102 and digital design system 104. The server device(s) 102 utilizes the digital design system 104 to generate, track, store, process, receive, and transmit electronic data including preliminary coloring pages, coloring pages, and preview images. For example, the server device(s) 102 receives or monitors interactions across the client device(s) 110. In some embodiments, the server device(s) 102 transmits content to the client device(s) 110 to cause the client device(s) 110 to display content associated with generating coloring pages. For example, the server device(s) 102 presents coloring pages to client device(s) 110 and displays the coloring pages on the client device(s) 110 with the coloring pages displayed corresponding to system need (e.g., provides coloring pages and preview images for display via the client application 112). The server device(s) 102 further accesses and utilizes the digital document repository 114 to store and retrieve information such as stored digital documents, reference images, preliminary coloring pages, coloring pages, and/or other data.

Additionally, the server device(s) 102 includes all, or a portion of, the coloring page generation system 106. For example, the coloring page generation system 106 operates on the server device(s) 102 to access digital content (including reference images and coloring pages), determine digital content changes, and provide localization of content changes to the client device(s) 110. In one or more embodiments, via the server device(s) 102, the coloring page generation system 106 generates and displays coloring pages and/or preview images based on the client device(s) 110 input. Example components of the coloring page generation system 106 will be described below with regard to FIG. 16.

Furthermore, as shown in FIG. 1, the illustrated system includes the client device(s) 110. In some embodiments, the client device(s) 110 include, but are not limited to, mobile devices (e.g., smartphones, tablets), laptop computers, desktop computers, or another type of computing devices, including those explained below in reference to FIG. 16. Some embodiments of client device(s) 110 are operated by a user to perform a variety of functions via client application 112 such as the generation of coloring pages. The client device(s) 110 include one or more applications (e.g., the client application 112) that access, edit, modify, store, and/or provide, for display, digital image content. For example, in some embodiments, the client application 112 include a software application installed on the client device(s) 110. In other cases, however, the client application 112 include a web browser or other application that accesses a software application hosted on the server device(s) 102.

In one or more embodiments, the coloring page generation system 106 is implemented in whole, or in part, by the individual elements of the environment 100. Indeed, as shown in FIG. 1, the coloring page generation system 106 is implemented with regard to the server device(s) 102 and the client device(s) 110. In particular embodiments, the coloring page generation system 106 on the client device(s) 110 comprises a web application, a native application installed on the client device(s) 110 (e.g., a mobile application, a desktop application, a plug-in application, etc.), or a cloud-based application where part of the functionality is performed by the server device(s) 102.

In additional or alternative embodiments, the coloring page generation system 106 on the client device(s) 110 represents and/or provides the same or similar functionality as described herein in connection with the coloring page generation system 106 on the server device(s) 102. In some embodiments, the coloring page generation system 106 on the server device(s) 102 supports the coloring page generation system 106 on the client device(s) 110.

In some embodiments, the coloring page generation system 106 includes a web hosting application that allows the client device(s) 110 to interact with content and services hosted on the server device(s) 102. To illustrate, in one or more embodiments, the client device(s) 110 accesses a web page or computing application supported by the server device(s) 102. The client device(s) 110 provides input to the server device(s) 102 (e.g., text prompts). In response, the coloring page generation system 106 on the server device(s) 102 generates coloring pages and/or preview images. The server device(s) 102 then provides the coloring pages and/or preview images to the client device(s) 110.

In some embodiments, the coloring page generation system 106 includes the third-party system(s) 120 and documents 122. To illustrate, in one or more embodiments, the coloring page generation system 106 interacts with content and services hosted on the third-party system(s) 120. To illustrate, in one or more embodiments, the coloring page generation system 106 accesses a web page or computing application supported by the third-party system(s) 120. The third-party system(s) 120 provide input to the coloring page generation system 106 (e.g., media generation diffusion model prompts) and documents 122 (e.g., source documents, reference images). In response, the coloring page generation system 106 generates/modifies digital content including generating preliminary coloring pages and coloring pages. The coloring page generation system 106 then provides the digital content to the third-party system(s) 120.

In another embodiment, the coloring page generation system 106 on the server device(s) 102 supports the coloring page generation system 106 on the client device(s) 110. For instance, in some cases, the coloring page generation system 106 on the server device(s) 102 generates or learns parameters for one or more machine learning models (e.g., a media generation diffusion model). The coloring page generation system 106 then, via the server device(s) 102, provides the one or more trained machine learning models to the client device(s) 110. In other words, the client device(s) 110 obtains (e.g., downloads) the one or more machine learning models (e.g., with any learned parameters) from the server device(s) 102. Once downloaded, the one or more machine learning models on the client device(s) 110 utilizes the one or more trained machine learning models to generate coloring pages independent from the server device(s) 102.

In some embodiments, the environment 100 has a different arrangement of components and/or has a different number or set of components altogether. For example, in certain embodiments, the client device(s) 110 communicate directly with the server device(s) 102, bypassing the network 108. As another example, the environment 100 includes a third-party server comprising a content server and/or a data collection server.

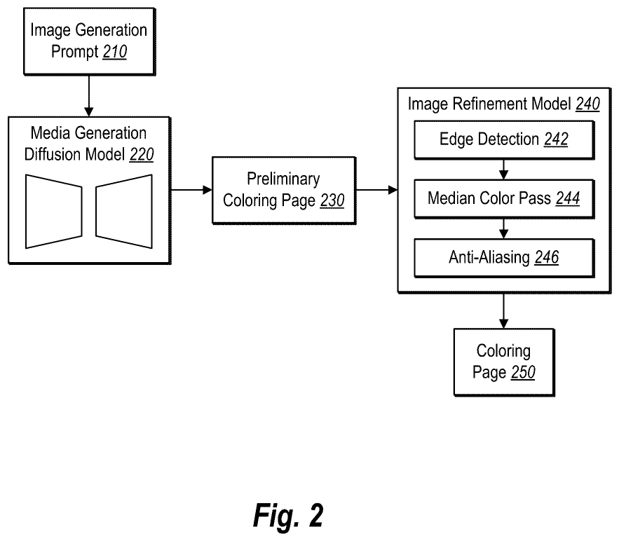

As previously mentioned, in one or more embodiments, the coloring page generation system 106 generates coloring pages from a text prompt. For instance, FIG. 2 illustrates an example of generating a coloring page from a text prompt utilizing a media generation diffusion model and an image refinement model in accordance with one or more embodiments. Additional detail regarding the various acts of FIG. 2 is provided thereafter with reference to subsequent figures.

As shown in FIG. 2, the coloring page generation system 106 utilizes an image generation prompt 210 to prompt a media generation diffusion model 220 to generate a preliminary coloring page 230. In one or more embodiments, the image generation prompt 210 includes or refers to a refined prompt which includes instructions engineered to guide the media generation diffusion model 220 to generate the preliminary coloring page 230 which replicates visual characteristics from a reference image. In one or more embodiments, the coloring page generation system 106 generates the image generation prompt 210 from a text prompt received via an interaction with a user device specifying one or more elements to include in the coloring page 250. In certain embodiments, the coloring page generation system 106 generates the image generation prompt 210 by combining the text prompt, a reference image, and prompt keywords.

To illustrate, the coloring page generation system 106 generates the image generation prompt 210 by tailoring the instructions of the text prompt to guide the media generation diffusion model 220 to generate the preliminary coloring page 230. In some embodiments, the coloring page generation system 106 generates the image generation prompt 210 to guide the media generation diffusion model 220 to generate the preliminary coloring page 230 by incorporating particular qualities of a digital coloring page by emphasizing clear, continuous outlines and simplified shapes to generate an image suitable for coloring. In one or more embodiments, the coloring page generation system 106 generates the image generation prompt 210 to guide the media generation diffusion model 220 to generate the preliminary coloring page 230 to mimic traditional coloring books with black outlines, no gaps, clear edges, big/distinct coloring spaces, harmonious composition, and/or moderate details.

As further shown, the coloring page generation system 106 utilizes the media generation diffusion model 220 to generate the preliminary coloring page 230 based on the image generation prompt 210. For example, the media generation diffusion model 220 generates the preliminary coloring page 230 utilizing continuous outlines and fillable areas to portray a scene, object, or character specified by the image generation prompt 210.

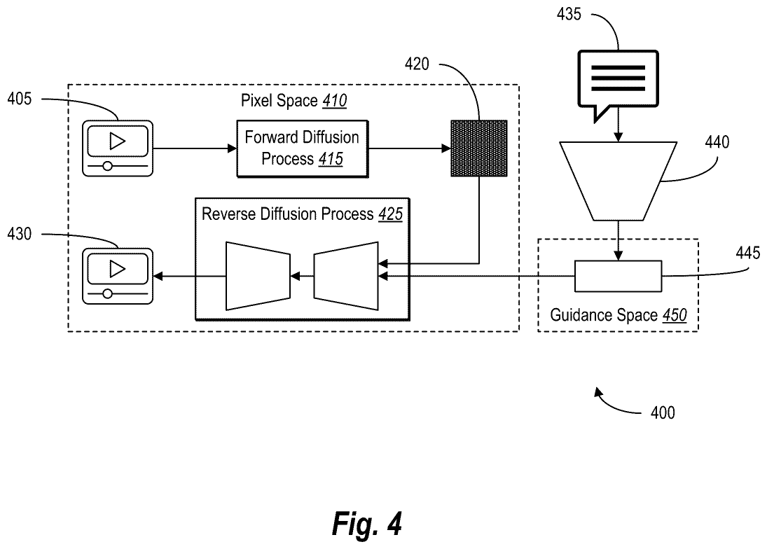

In one or more embodiments, the coloring page generation system 106 utilizes a generative neural network for the media generation diffusion model 220 as described in relation to FIGS. 4-9. For example, the media generation diffusion model 220 encodes the image generation prompt 210 into a guidance vector to guide the generation of the preliminary coloring page 230. In addition, the media generation diffusion model 220 utilizes the reference image as a visual template to define specific features, such as the style or the level of detail for the outlines. During a reverse diffusion process, the media generation diffusion model 220 integrates the encoded guidance from the image generation prompt 210 and the reference image while gradually removing noise from an initially noisy image.

In some embodiments, the media generation diffusion model 220 utilizes a U-Net architecture to perform the reverse diffusion process. For example, the media generation diffusion model 220 down-samples and up-samples the image data, integrating the guidance features at various stages. The media generation diffusion model utilizes U-Net to maintain precise control over image features at different resolutions, to generate well-defined edges and clear outlines for the preliminary coloring page 230. By using skip connections, the U-Net preserves fine details from earlier layers, contributing to the clarity and cohesiveness of the preliminary coloring page 230. Thus, the media generation diffusion model 220 generates the preliminary coloring page 230 that aligns closely with both the content described in the image generation prompt 210 and the stylistic cues from the reference image.

As further shown, the coloring page generation system 106 utilizes an image refinement model 240 to generate a coloring page 250 from the preliminary coloring page 230. For example, the image refinement model 240 includes or refers to a model that systematically generates a coloring page 250 by generating a two-tone image from the preliminary coloring page 230, removing details from the two-tone image based on a detail threshold, and utilizing anti-aliasing to enhance the outlines within the two-tone image.

In certain embodiments, the coloring page generation system 106 utilizes the image refinement model 240 to convert the preliminary coloring page into a two-tone image 242. For example, the coloring page generation system 106 determines a luma value for the pixels within the preliminary coloring page 230 to convert the preliminary coloring page into dark and light regions (e.g., a black and white image). In some cases, the coloring page generation system 106 defines the elements within the preliminary coloring page by converting dark areas to continuous outlines (e.g., borders or edges) and converting the light areas to fillable regions (or background). In this way, the coloring page generation system 106 uses a two-tone transformation to generate a two-tone image 242, wherein the outlines and fillable areas are distinct.

After creating the two-tone image 242, the coloring page generation system 106 utilizes the image refinement model 240 to refine the outlines by applying a detail threshold 244. In this way, the image refinement model 240 removes unnecessary details from the continuous outlines to simplify the coloring page 250. In some embodiments, the image refinement model 240 removes unnecessary details that are not part of the continuous outlines (e.g., excess marks or unconnected lines) to simplify the coloring page 250. For example, the image refinement model 240 identifies and removes narrow fillable regions and borders that are only a few pixels wide, which detract from the appearance and useability of the continuous outlines for the coloring page 250. By eliminating these extraneous details, the image refinement model 240 simplifies the two-tone image 242 while retaining the continuous outlines that portray elements of the coloring image.

After refining the outlines utilizing the detail threshold 244, the coloring page generation system 106 utilizes the image refinement model 240 to perform anti-aliasing 246. For example, the image refinement model 240 utilizes anti-aliasing 246 to further enhance the two-tone image 242 and generate the coloring page 250. In some cases, the image refinement model 240 utilizes anti-aliasing 246 to smooth the continuous outlines of the two-tone image 242, eliminating jaggedness in the continuous outlines that resulted from previous steps. In some cases, the image refinement model 240 utilizes anti-aliasing 246 to generate continuous outlines that are crisp and clear, to create a polished and professional look for the coloring page 250. In this way, the image refinement model 240 generates the coloring page 250 as a high-quality coloring template with clean continuous outlines (that portray elements from the text prompt) and with distinct fillable regions that is optimized for coloring.

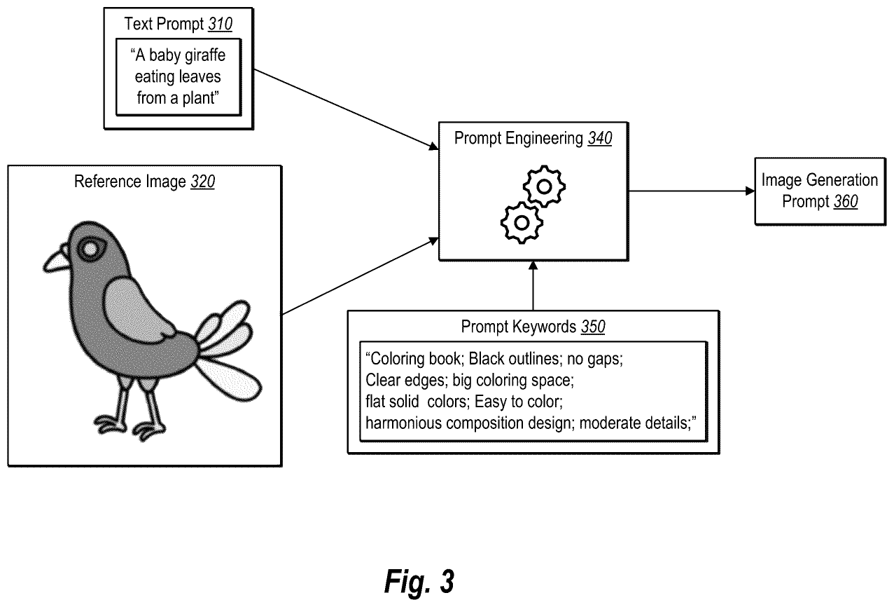

As mentioned, the coloring page generation system 106 utilizes an image generation prompt to guide a media generation diffusion model to generate a preliminary coloring page. In this way, the coloring page generation system 106 guides a media generation diffusion model to generate an image that aligns with the requirements for a coloring page. FIG. 3 illustrates an example of generating an image generation prompt in accordance with one or more embodiments.

As shown in FIG. 3, the coloring page generation system 106 utilizes prompt engineering 340 to generate an image generation prompt 360. For example, the coloring page generation system 106 utilizes prompt engineering 340 to generate the image generation prompt 360 which guides the media generation diffusion model to generate artwork that meets the specific needs of a coloring page. As shown, in one or more embodiments, the coloring page generation system 106 combines a text prompt 310, a reference image 320 and prompt keywords 350 to generate the image generation prompt 360.

In one or more embodiments, the coloring page generation system 106 utilizes a text prompt 310 to generate the image generation prompt 360. In one or more embodiments, the text prompt 310 includes or refers to a descriptive prompt received via an interaction with a user device a text prompt 310 including textual content describing content for a coloring page. In some cases, the text prompt 310 includes a simple description of one or more elements to display in a coloring page such as the scene, object, character, or action. In some embodiments, the text prompt 310 includes a straightforward description that includes the elements desired for the coloring page without including complex instructions related to the technical aspects of creating the coloring page (e.g., formatting, style, outlines, complexity). To illustrate, in some embodiments, the text prompt 310 includes the text of “a baby giraffe eating leaves from a plant,” “a playful puppy in a garden,” or “a magical unicorn in the clouds.”

To illustrate, in some embodiments, the text prompt 310 includes one or more elements for the coloring page. For example, the text prompt 310 includes elements such as a scene, object, character, or action, subject, setting, style, mood, or other attributes. In some embodiments, the text prompt 310 includes an indication of a subject for the main focus of a coloring page. For example, the indication of the subject can include a person, an object, an animal, or a scene (e.g., “a giraffe” or “a forest”). In some cases, the text prompt 310 includes an indication of an environment or background to portray the subject, such as outdoor, urban, or indoor. (e.g., “inside a cabin” or “floating in space”). In certain embodiments, the text prompt 310 includes an indication of a movement or interaction, such as how elements in the image interact with other elements (e.g., “walking through rain,” or “playing with a ball”). In some cases, the text prompt 310 includes specific details or attributes of the image (e.g., “with geometric patterns” or “in the summertime”).

The coloring page generation system 106 utilizes a reference image 320 to generate the image generation prompt 360. In one or more embodiments, the reference image 320 includes or refers to an image used as a visual guide for the media generation diffusion model to generate a coloring page with well-defined outlines and fillable areas, which adheres to a particular style and/or complexity. Utilizing the reference image 320, the coloring page generation system 106 replicates visual characteristics of the reference image 320 such as outline qualities, a shape complexity, or an overall artistic style. In certain embodiments, the reference image 320 provides the media generation diffusion model with cues to integrate these specific characteristics into the generated coloring page.

For example, the coloring page generation system 106 utilizes prompt engineering 340 to incorporate reference image 320 to generate the image generation prompt 360. In this way, the coloring page generation system 106 generates an image generation prompt 360 engineered to guide a media generation diffusion model to replicate the stylistic features of the reference image 320 and generate a preliminary coloring page. In some cases, the coloring page generation system 106 incorporates reference image 320 in the image generation prompt 360 to produce a coloring page tailored to specific stylistic preferences such as a color scheme, line thickness, color palette, outlines, form, design, style, or overall aesthetic.

In one or more embodiments, the reference image 320 includes key characteristics. To illustrate, as shown in FIG. 3, by incorporating the reference image 320 in the image generation prompt 360 of a cartoon-style bird with bold outlines and vibrant colors, the coloring page generation system 106 guides the media generation diffusion model to generate a coloring page that replicates the stylistic characteristics of the cartoon-style bird. As also shown, the reference image 320 incorporates a vibrant color palette with a range of bright and contrasting colors, such as red, orange, yellow, blue, and green. When the reference image 320 is used as a reference, the media generation diffusion model incorporates similarly vibrant colors into the generated preliminary coloring page and/or preview image, leading to results that are engaging and visually appealing.

As further shown in FIG. 3, the reference image 320 includes sharp, well-defined edges that clearly delineate different areas of the image. For example, the reference image 320 is free from visual noise or unnecessary details that complicate the generation of a preliminary coloring page. The reference image 320 is defined by thick black outlines that clearly delineate the different parts of the bird's body, making the image easy to interpret and color. Based on the reference image 320, the coloring page generation system 106 guides the media generation diffusion model to produce a preliminary coloring page with equally strong and distinct outlines.

In one or more embodiments, the coloring page generation system 106 utilizes a reference image 320 based on a simplified form for the reference image 320. As shown in FIG. 3, the reference image 320 is rendered in a simplified, cartoon-like style, with exaggerated proportions (such as large eyes and short legs) and minimal intricate details. The coloring page generation system 106 utilizes this stylization to generate a preliminary coloring page that is both approachable and easy to color. When the media generation diffusion model uses the reference image 320 as a reference, the media generation diffusion model adopts similar simplifications, creating artwork that is not overly complex or detailed, and thus better suited for the purpose of a coloring page.

Furthermore, the coloring page generation system 106 utilizes the reference image 320 which embodies a particular artistic style for the coloring page (e.g., cartoonish, playful, whimsical, geometric, etc.). In this way, the coloring page generation system 106 guides the media generation diffusion model to generate a preliminary coloring page based on the style of the reference image 320. To illustrate, as shown in FIG. 3, the coloring page generation system 106 utilizes the reference image 320 which is playful, with a cheerful and friendly appearance that appeals to a younger audience. The media generation diffusion model, when guided by the reference image 320, produces artwork that is whimsical and inviting, making the coloring pages more enjoyable for users, especially children. In this way, the coloring page generation system 106 maintains a similar level of simplicity to the reference image 320 when generating a preliminary coloring page, which is easier to convert into black-and-white outlines suitable for coloring.

As also shown, the reference image 320 includes a high contrast between different parts of the image. For example, the coloring page generation system 106 utilizes the reference image 320 to provide a specific style and aesthetic that the generated preliminary coloring page is expected to replicate. By providing this reference, the coloring page generation system 106 guides the media generation diffusion model to produce a preliminary coloring page that is consistent in terms of visual elements like line thickness, color usage, and overall composition. The bold outlines and clear separations in the reference image 320 help the media generation diffusion model to define areas within the generated preliminary coloring page more distinctly, ensuring that the final image has the necessary clarity and structure for a coloring page. In this way, the coloring page generation system 106 guides the media generation diffusion model to generate a preliminary coloring page that adheres to a certain brand or design guideline.

As also shown in FIG. 3, the coloring page generation system 106 utilizes the prompt engineering 340 to incorporate prompt keywords 350 into the image generation prompt 360. In one or more embodiments, the prompt keywords 350 include or refer to additional terms or phrases incorporated into the image generation prompt 360 to fine-tune the preliminary coloring page generation process. In some cases, prompt keywords 350 act as modifiers that guide the media generation diffusion model to focus on or enhance specific qualities within the generated preliminary coloring page. In some cases, the coloring page generation system 106 appends the prompt keywords 350 as a suffix to the text prompt 310. In one or more embodiments, prompt keywords 350 emphasize particular aspects of the image, such as “high contrast,” “minimalist,” “detailed,” or “pastel colors.” As shown in FIG. 3, prompt keywords 350 include keywords such as “coloring book; black outlines; no gaps; clear edges; big coloring space; flat solid colors; easy to color; harmonious composition design; moderate details.”

As mentioned, the coloring page generation system 106 combines the prompt keywords 350 with the text prompt 310 to generate the image generation prompt 360. For example, by using the prompt keywords 350 of “coloring book,” the coloring page generation system 106 instructs the media generation diffusion model to produce a preliminary coloring page that mimics traditional coloring books. In this way, the coloring page generation system 106 guides the media generation diffusion model to focus on generating a preliminary coloring page with simple, bold lines and large, open areas that are easy to fill with color which are not overly detailed or complex.

Additionally, by using the prompt keywords 350 of “black outlines,” the coloring page generation system 106 instructs the media generation diffusion model to produce a preliminary coloring page with distinct outlines. Using prompt engineering, the graph-cut partitioning system 106 guides the boundaries towards a dark color, which is interpreted as a boundary. In this way, the coloring page generation system 106 guides the media generation diffusion model to generate all major elements in the preliminary coloring page bordered by strong dark lines that provide clear boundaries.

Moreover, by using the prompt keywords 350 of “no gaps,” the coloring page generation system 106 instructs the media generation diffusion model to produce a preliminary coloring page that is continuous with uninterrupted outlines. In this way, the coloring page generation system 106 guides the media generation diffusion model to prevent the unintentional merging of different areas in the preliminary coloring page and provide distinct regions (e.g., different parts of a character or object) are clearly defined.

Furthermore, by using the prompt keywords 350 of “clear edges,” the coloring page generation system 106 reinforces for the media generation diffusion model of the importance of sharp, well-defined edges in the preliminary coloring page. In this way, the coloring page generation system 106 guides the media generation diffusion model to generate the preliminary coloring page with crisp, clear edges, with easily distinguishable elements for a clean and professional-looking coloring page.

In addition, by using the prompt keywords 350 of “big coloring space,” the coloring page generation system 106 guides the media generation diffusion to create larger, more open areas within the preliminary coloring page. In this way, the coloring page generation system 106 guides the media generation diffusion model to generate a preliminary coloring page that features larger regions with less detail that are easier for users to fill in with color.

Moreover, by using the prompt keywords 350 of “flat solid colors,” the coloring page generation system 106 guides the media generation diffusion model to use flat, uniform colors in the generated preliminary coloring page. In this way, the coloring page generation system 106 guides the media generation diffusion model to generate the preliminary coloring page with flat colors which simplify the process of converting the image to a black-and-white outline. For example, by generating a preliminary coloring page without gradients or complex shading, the resulting outlines are clear and free of unnecessary detail and are more efficiently converted into a coloring page.

Additionally, by using the prompt keywords 350 of “easy to color,” the coloring page generation system 106 guides the media generation diffusion model to produce a preliminary coloring page that is simple in design, with minimal intricate details. In this way, the coloring page generation system 106 guides the media generation diffusion model to generate the preliminary coloring page that is user-friendly, with clear and distinct areas that are easy to color.

Moreover, by using the prompt keywords 350 of “flat solid colors,” the coloring page generation system 106 guides the media generation diffusion model to use flat, uniform colors in the generated preliminary coloring page. In this way, the coloring page generation system 106 guides the media generation diffusion model to generate the preliminary coloring page with flat colors to simplify the process of converting the image to a black-and-white outline. For example, by generating a preliminary coloring page without gradients or complex shading, the resulting outlines are clear and free of unnecessary detail and are more efficiently converted into a coloring page.

Moreover, by using the prompt keywords 350 of “harmonious composition design,” the coloring page generation system 106 guides the media generation diffusion model to generate a preliminary coloring page with an overall layout that is balanced and aesthetically pleasing. In this way, the coloring page generation system 106 guides the media generation diffusion model to generate the preliminary coloring page with a well-composed design, where all elements are arranged in a visually appealing way that appears cohesive.

In addition, by using the prompt keywords 350 of “moderate details,” the coloring page generation system 106 guides the media generation diffusion model to generate a preliminary coloring page that includes a moderate level of detail. In this way, the coloring page generation system 106 guides the media generation diffusion model to balance details in the image, ensuring that the preliminary coloring page is interesting without being overwhelming.

In this way, the coloring page generation system 106 generates the image generation prompt 360 to guide a media generation diffusion model to generate a preliminary coloring page optimized for coloring that includes continuous outlines and fillable regions, portrays elements from the text prompt 310, and reflects the style of the reference image 320.

As mentioned, the coloring page generation system 106 generates a preliminary coloring page from an image generation prompt utilizing a media generation diffusion model. In some cases, the coloring page generation system 106 utilizes a guided diffusion model for the media generation diffusion model. FIG. 4 illustrates an example of a guided diffusion model in accordance with one or more embodiments.

### Architecture: Pixel Diffusion

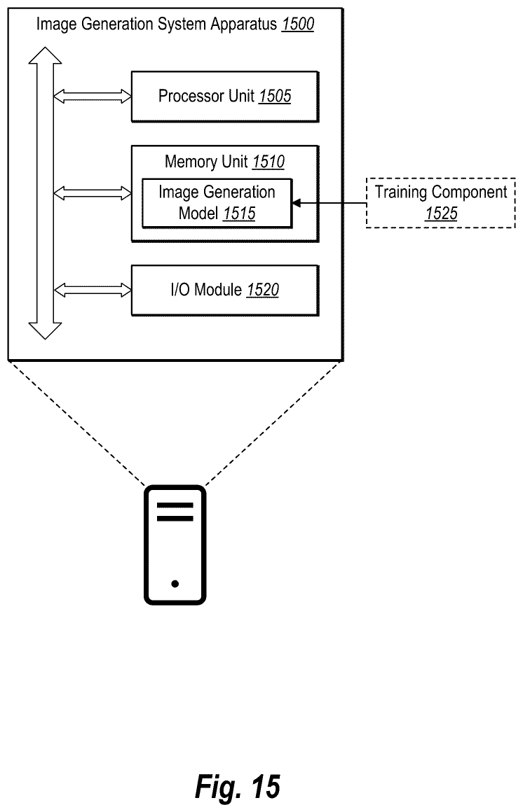

In particular, FIG. 4 shows an example of a guided diffusion model 400 according to aspects of the present disclosure. In some examples, guided diffusion model 400 describes the operation and architecture of a media generation diffusion model 1515 described with reference to FIG. 15. The guided diffusion model 400 depicted in FIG. 4 is an example of, or includes aspects of, the media generation diffusion model 220 as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, the guided diffusion model 400 may take an original media item 405 in a pixel space 410 as input and apply forward diffusion process 415 to gradually add noise to the original media item 405 to obtain noisy media item 420 at various noise levels.

Next, a reverse diffusion process 425 (e.g., a U-Net) gradually removes the noise from the noisy media item 420 at the various noise levels to obtain an output media item 430. In some cases, an output media item 430 is created from each of the various noise levels. The output media item 430 can be compared to the original media item 405 to train the reverse diffusion process 425.

The reverse diffusion process 425 can also be guided based on a text prompt 435, or another guidance prompt, such as an image generation prompt (e.g., the image generation prompt 210), a reference image, a layout, a segmentation map, etc. The text prompt 435 can be encoded using a text encoder 440 (e.g., a multimodal encoder) to obtain guidance features 445 in guidance space 450. The guidance features 445 can be combined with the noisy media item 420 at one or more layers of the reverse diffusion process 425 to ensure that the output media item 430 includes content described by the text prompt 435. For example, guidance features 445 can be combined with the noisy features using a cross-attention block within the reverse diffusion process 425.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

### Architecture: U-Net

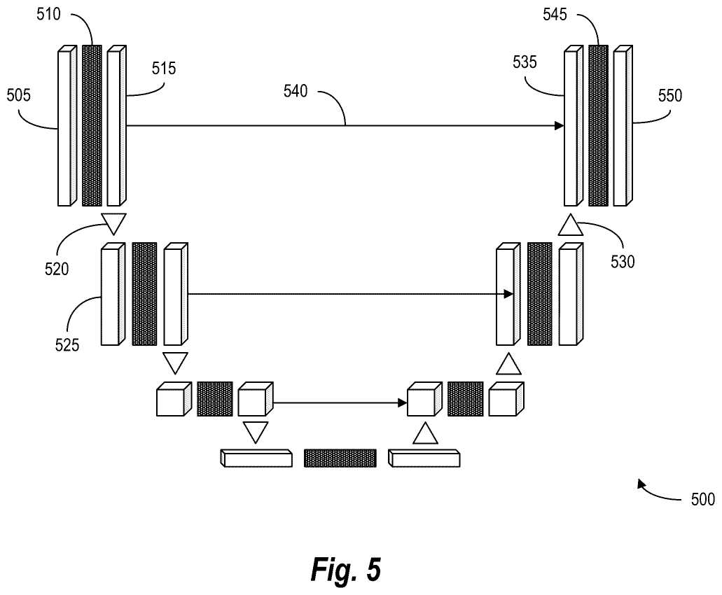

FIG. 5 shows an example of a U-Net 500 according to aspects of the present disclosure. In some examples, U-Net 500 is an example of the component that performs the reverse diffusion process 425 of guided diffusion model 400 described with reference to FIG. 4 and includes architectural elements of the media generation diffusion model 1515 described with reference to FIG. 15. The U-Net 500 depicted in FIG. 5 is an example of, or includes aspects of, the architecture used within the reverse diffusion process described with reference to FIG. 4.

In some examples, diffusion models are based on a neural network architecture known as a U-Net. The U-Net 500 takes input features 505 having an initial resolution and an initial number of channels and processes the input features 505 using an initial neural network layer 510 (e.g., a convolutional network layer) to produce intermediate features 515. The intermediate features 515 are then down-sampled using a down-sampling layer 520 such that the down-sampled features 525 features have a resolution less than the initial resolution and a number of channels greater than the initial number of channels.

This process is repeated multiple times, and then the process is reversed. That is, the down-sampled features 525 are up-sampled using up-sampling process 530 to obtain up-sampled features 535. The up-sampled features 535 can be combined with intermediate features 515 having the same resolution and number of channels via a skip connection 540. These inputs are processed using a final neural network layer 545 to produce output features 550. In some cases, the output features 550 have the same resolution as the initial resolution and the same number of channels as the initial number of channels.

In some cases, U-Net 500 takes additional input features to produce conditionally generated output. For example, the additional input features could include a vector representation of an input prompt, an image generation prompt, or a reference image. The additional input features can be combined with the intermediate features 515 within the neural network at one or more layers. For example, a cross-attention module can be used to combine the additional input features and the intermediate features 515.

### Inference: Conditional Generation

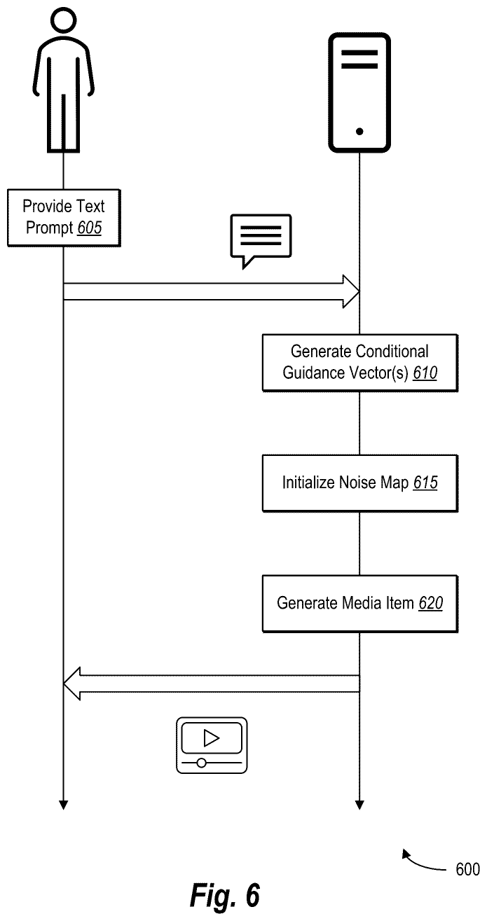

FIG. 6 shows an example of a method 600 for conditional media generation (e.g., preliminary coloring page 230) according to aspects of the present disclosure. In some examples, method 600 describes an operation of the media generation diffusion model 1515 described with reference to FIG. 15 such as an application of the guided diffusion model 400 described with reference to FIG. 4. In some examples, these operations are performed by a system including a processor executing a set of codes to control functional elements of an apparatus such as the media generation model described in FIG. 4.

Additionally or alternatively, steps of the method 600 may be performed using special-purpose hardware. Generally, these operations are performed according to the methods and processes described in accordance with aspects of the present disclosure. In some cases, the operations described herein are composed of various sub-steps or are performed in conjunction with other operations.

At operation 605, a user provides a text prompt (e.g., the image generation prompt 210) describing content to be included in a generated media item. For example, the coloring page generation system may provide the prompt “a baby giraffe eating leaves from a plant.” In some examples, guidance can be provided in a form other than text, such as via an image, a reference image, a sketch, or a layout.

At operation 610, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 615, a noise map is initialized that includes random noise. The noise map may be in a pixel space or a latent space. By initializing a media item with random noise, different variations of a media item including the content described by the conditional guidance can be generated.

At operation 620, the system generates a media item based on the noise map and the conditional guidance vector. For example, the media item may be generated using a reverse diffusion process as described with reference to FIG. 4.

### Inference: Reverse Diffusion

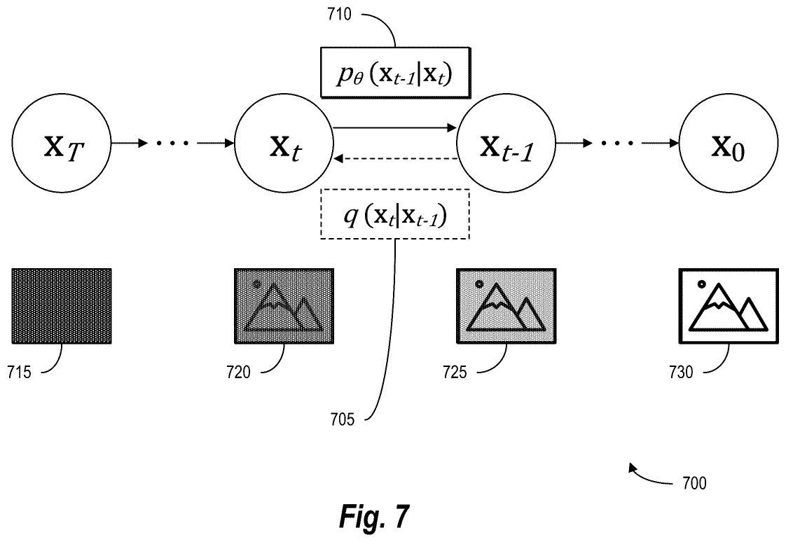

FIG. 7 shows a diffusion process 700 according to aspects of the present disclosure. In some examples, diffusion process 700 describes an operation of the media generation diffusion model 1515 described with reference to FIG. 15, such as the reverse diffusion process 425 of guided diffusion model 400 described with reference to FIG. 4.

As described above with reference to FIG. 4, using a diffusion model can involve both a forward diffusion process 705 for adding noise to a media item (or features in a latent space) and a reverse diffusion process 710 for denoising the media item (or features) to obtain a denoised media item. The forward diffusion process 705 can be represented as q(xₜ|xₜ₋₁), and the reverse diffusion process 710 can be represented as p(xₜ₋₁|xₜ). In some cases, the forward diffusion process 705 is used during training to generate media items with successively greater noise, and a neural network is trained to perform the reverse diffusion process 710 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 710, the model begins with noisy data x_{T}, such as a noisy media item 715 and denoises the data to obtain the p(xₜ₋₁|xₜ). At each step t−1, the reverse diffusion process 710 takes xₜ, such as first intermediate media item 720, and t as input. Here, t represents a step in the sequence of transitions associated with different noise levels, The reverse diffusion process 710 outputs xₜ₋₁, such as second intermediate media item 725 iteratively until x-reverts back to x₀, the original media item 730. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and î represents the generated item with high quality.

### Training: Machine Learning

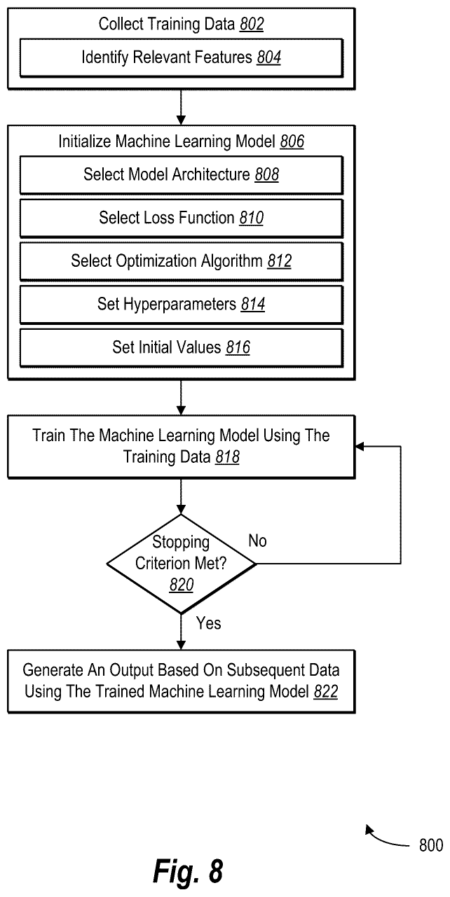

FIG. 8 is a flow diagram depicting an algorithm as a step-by-step procedure for procedure 800 in an example implementation of operations performable for training a machine-learning model. In some embodiments, the procedure 800 describes an operation of the training component 1525 described for configuring the media generation diffusion model 1515 as described with reference to FIG. 15. The procedure 800 provides one or more examples of generating training data, use of the training data to train a machine-learning model, and use of the trained machine-learning model to perform a task.

To begin, in this example, a machine-learning system collects training data (block 802) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify relevant features that are relevant (block 804) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 806). Initialization of the machine-learning model includes selecting a model architecture (block 808) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 810). The loss function is utilized to measure a difference between an output of the machine-learning model (i.e., predictions) and target values (e.g., as expressed by the training data) to be used to train the machine-learning model. Additionally, an optimization algorithm is selected (block 812) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 816) examples of which includes initializing weights and biases of nodes to improve efficiency in training and computational resources consumption as part of training. Hyperparameters are also set (block 814) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 818) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 820), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 820), the procedure 800 continues training of the machine-learning model using the training data (block 818) in this example.

If the stopping criterion is met (“yes” from decision block 820), the trained machine-learning model is then utilized to generate an output based on subsequent data (block 822). The trained machine-learning model, for instance, is trained to perform a task as described above and therefore once trained is configured to perform that task based on subsequent data received as an input and processed by the machine-learning model.

### Training: Diffusion Training

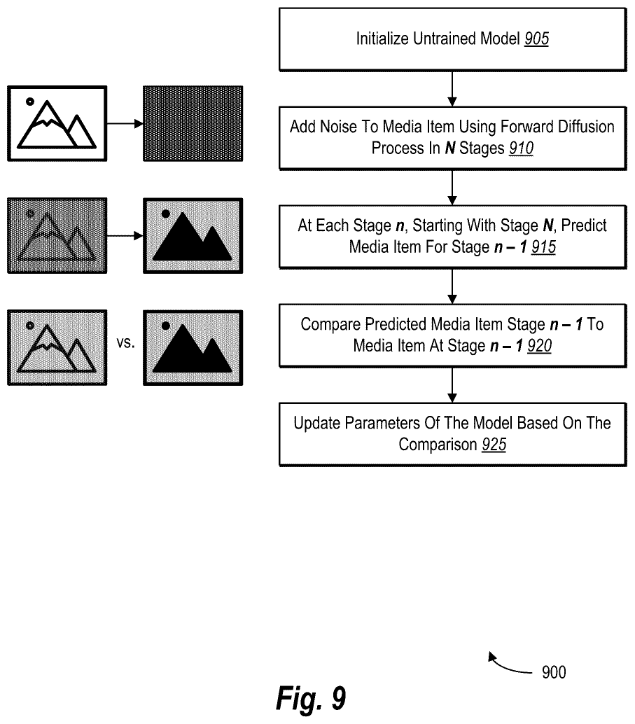

FIG. 9 shows an example of a method 900 for training a diffusion model according to aspects of the present disclosure. In some embodiments, the method 900 describes an operation of the training component 1525 described for configuring the media generation diffusion model 1515 as described with reference to FIG. 15. The method 900 represents an example for training a reverse diffusion process as described above with reference to FIG. 7. In some examples, these operations are performed by a system including a processor executing a set of codes to control functional elements of an apparatus, such as the guided diffusion model described in FIG. 4.

Additionally or alternatively, certain processes of method 900 may be performed using special-purpose hardware. Generally, these operations are performed according to the methods and processes described in accordance with aspects of the present disclosure. In some cases, the operations described herein are composed of various sub-steps or are performed in conjunction with other operations.

At operation 905, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 910, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 915, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 920, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 925, the system updates parameters of the model based on the comparison. For example, parameters of a U-Net may be updated using gradient descent. Time-dependent parameters of the Gaussian transitions can also be learned.

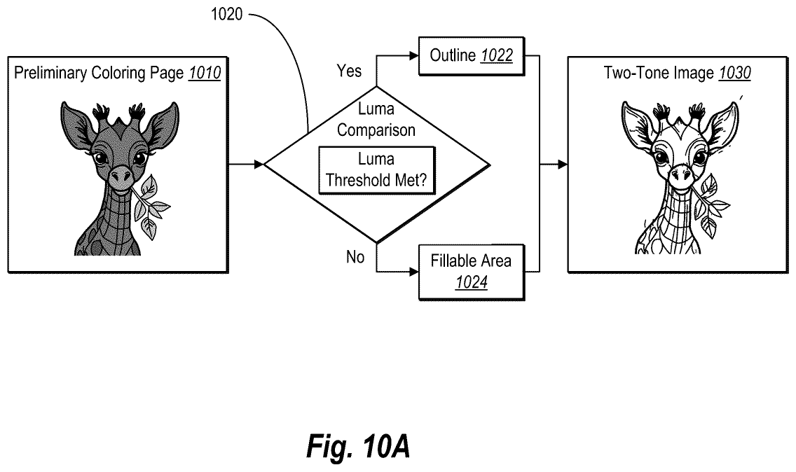

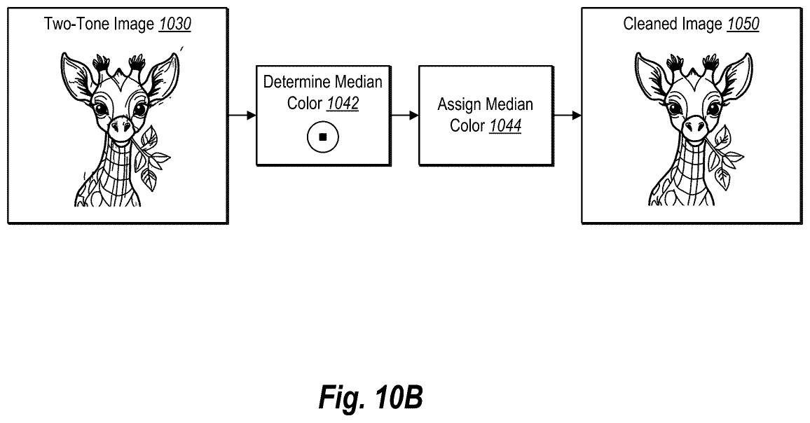

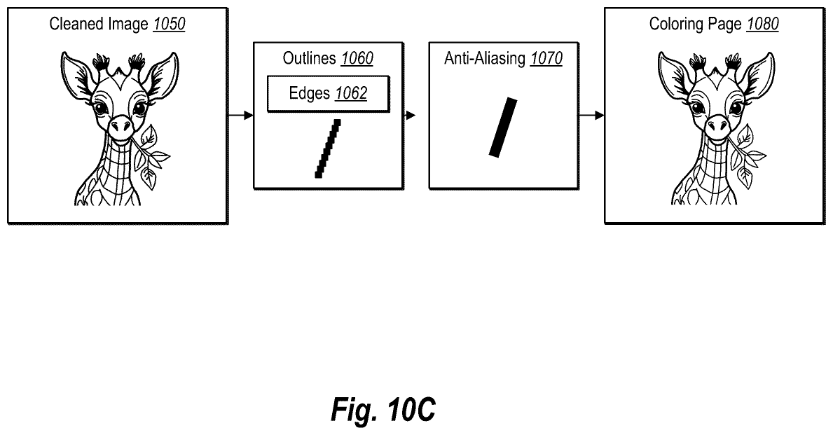

As just described, the coloring page generation system 106 utilizes a media generation diffusion model to generate a preliminary coloring page. In addition, the coloring page generation system 106 utilizes an image refinement model to refine the preliminary coloring page and generate a coloring page. FIGS. 10A-10C provide examples of utilizing an image refinement model to refine the preliminary coloring page by generating a two-tone image from the preliminary coloring page, removing details from the two-tone image based on a detail threshold, and utilizing anti-aliasing to enhance the outlines within the two-tone image to generate the coloring page. In particular, FIG. 10A illustrates an example of generating a two-tone image from a preliminary coloring page in accordance with one or more embodiments.

As shown in FIG. 10A, the coloring page generation system 106 converts the preliminary coloring page 1010 into a two-tone image 1030. For example, the coloring page generation system 106 utilizes an edge detection process to convert the preliminary coloring page 1010 to a two-tone image 1030 (e.g., a black-and-white image), where the dark areas of the image represent edges or outlines, and the lighter areas represent fillable regions. As shown, the coloring page generation system 106 performs pixel-by-pixel processing on the preliminary coloring page 1010.

In one or more embodiments, the coloring page generation system 106 performs a luma comparison 1020 to generate the two-tone image 1030. For example, for pixels of the preliminary coloring page 1010, the coloring page generation system 106 calculates or determines a luminance (luma) value, by measuring the brightness of the pixels. In some cases, the coloring page generation system 106 determines a luma value that represents the grayscale intensity of the pixels in the preliminary coloring page 1010, where the grayscale intensity ranges from dark to light. As shown, the coloring page generation system 106 compares the calculated luma value of each pixel against a luma threshold (e.g., 0.2 lumas). If the luma value for a pixel is higher than the luma threshold (e.g., the pixel is brighter), the coloring page generation system 106 classifies the pixel as fillable area 1024. If the luma value for a pixel is lower or equal to the luma threshold (e.g., the pixel is darker), the coloring page generation system 106 classifies the pixel as an outline 1022. Based on the luma comparison 1020 the coloring page generation system 106 classifies the pixels in the preliminary coloring page as part of either the outline 1022 or as part of the fillable area 1024.

In one or more embodiments, the coloring page generation system 106 generates the two-tone image 1030 based on the outline 1022 and the fillable area 1024. For example, by processing all of the pixels within the preliminary coloring page 1010, the coloring page generation system 106 determines a classification assigning the pixels to either the outline 1022 or the fillable area 1024. Furthermore, the coloring page generation system 106 generates the two-tone image 1030 by combining the pixels of the outline 1022 and the pixels of the fillable area 1024.

The coloring page generation system 106 further refines the preliminary coloring page by removing details from the two-tone image 1030. FIG. 10B illustrates an example of generating a cleaned image 1050 from the two-tone image 1030 in accordance with one or more embodiments.

As shown in FIG. 10B, the coloring page generation system 106 cleans the two-tone image 1030 to generate a cleaned image 1050 through a median color pass. For example, the coloring page generation system 106 simplifies the two-tone image 1030 by removing unnecessary details based on median colors. In this way, the coloring page generation system 106 refines the preliminary coloring page and simplifies the two-tone image to generate a cleaned image 1050. For example, by smoothing the continuous outlines within the two-tone image 1030 and discarding pixels in regions that do not satisfy a median color for a threshold width, the coloring page generation system 106 removes narrow fillable regions and thin outlines. Indeed, by utilizing a median color pass, the coloring page generation system 106 smooths out tiny, unnecessary details that complicate the overall structure of the coloring page.

To illustrate, the coloring page generation system 106 performs an act 1042 to determine a median color within a specified region of a pixel. In some cases, the coloring page generation system 106 defines the region as an area with a diameter of a specified number of pixels (e.g., 3, 5, 7 pixels) from the center of the pixel being evaluated. In certain embodiments, the coloring page generation system 106 examines the colors of all the pixels within the region and calculates a median color value (e.g., dark or light). Furthermore, once the median color is calculated for the pixel, the coloring page generation system 106 performs an act 1044 to assign the median color value to the pixel. In this way the coloring page generation system 106 smooths the two-tone image 1030 by replacing small fluctuations in color with the most common or central value in the surrounding pixels.

The coloring page generation system 106 further refines the preliminary coloring page by smoothing the outlines in the cleaned image 1050. FIG. 10C illustrates an example of generating a coloring page 1080 from the cleaned image 1050 in accordance with one or more embodiments.

As shown in FIG. 10C, the coloring page generation system 106 cleans the two-tone image 1030 to generate a cleaned image 1050 using anti-aliasing 1070. For example, the coloring page generation system 106 identifies the outlines 1060 in the cleaned image 1050. In one or more embodiments, the coloring page generation system 106 identifies the edges 1062 of the outlines 1060 where the colors transition (e.g., such as the transition between an outline and a fillable area). As shown, at this stage, the outlines 1060 are sharp but may still exhibit rough or jagged edges due to pixelization.

Once the coloring page generation system 106 determines the edges 1062, the coloring page generation system 106 utilizes the anti-aliasing 1070 (e.g., an anti-aliasing algorithm) to blend or smooth the transition between the pixels of the edges 1062 and the neighboring pixels. For example, the coloring page generation system 106 blends the edges 1062 of the outlines 1060 to create smoother transitions between the outlines 1060 and the fillable areas. Based on the anti-aliasing 1070, the coloring page generation system 106 generates the coloring page with where the outlines 1060 are distinct and have smooth edges.

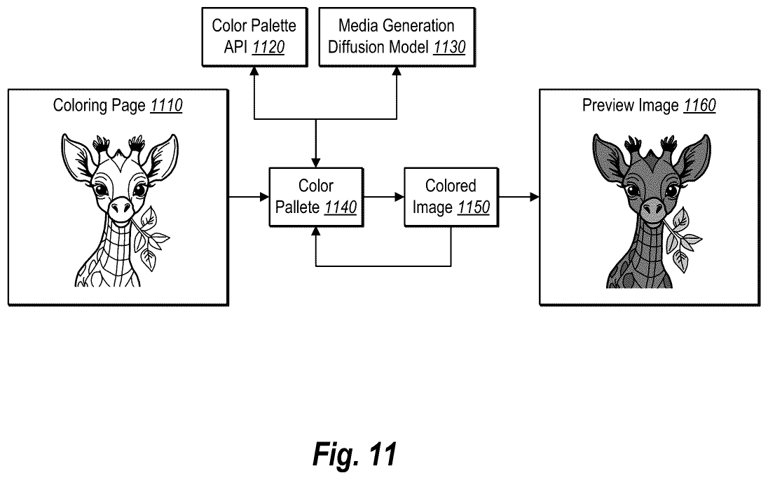

As mentioned, the coloring page generation system 106 generates a colored preview image which provides a colored example of a completed coloring page for the user device. FIG. 11 illustrates an example of generating a preview image for a coloring page in accordance with one or more embodiments.

As shown in FIG. 11, the coloring page generation system 106 generates a preview image 1160 from the coloring page 1110 utilizing a coloring page preview model. For example, the preview image 1160 includes or refers to a pre-colored example based on a selected or generated color palette. In some cases, the coloring page generation system 106 utilizes the coloring page preview model to generate the preview image 1160 by filling the fillable regions of the coloring page 1110 with colors selected from the color palette 1140. In some cases, the coloring page generation system 106 provides the preview image 1160 in conjunction with the coloring page within a coloring application. In some cases, the coloring page generation system 106 provides the preview image 1160 as a reference image for the coloring page.

As illustrated in FIG. 11, the coloring page generation system 106 selects or generates a color palette 1140. For example, the coloring page generation system 106 generates the color palette utilizing a color palette API 1120 and/or a media generation diffusion model 1130. In some cases, the coloring page generation system 106 utilizes the color palette API (e.g., Adobe Color/Adobe Assets API) to retrieve the color palette 1140 including predefined color schemes such as complementary or analogous colors. In some cases, the coloring page generation system 106 selects a color palette for the preview image by extracting a subset of colors from the preliminary coloring page. For example, the coloring page generation system 106 analyzes the preliminary coloring page generated by the media generation diffusion model 1130 to extract a color palette of the most prominent colors (e.g., 5 colors, 30 colors) that reflect the tones and hues used in the preliminary coloring page. In some cases, the coloring page generation system 106 generates the color palette 1140 based on the extracted color palette.

Furthermore, the coloring page generation system 106 generates the preview image 1160. As shown, the coloring page generation system 106 generate a colored image 1150 based on colors selected from the color palette 1140. In some cases, the coloring page generation system 106 generates the colored image 1150 by filling the fillable regions of the coloring page with colors selected from the color palette 1140. Furthermore, the coloring page generation system 106 generates the preview image 1160 from the colored image 1150.

In one or more embodiments, the coloring page generation system 106 recolors the colored image 1150 to generate the preview image 1160. For example, as shown in FIG. 11, the coloring page generation system 106 recolors the colored image 1150 based on an updated version of the color palette 1140. In some cases, the coloring page generation system 106 recolors the colored image 1150 with colors from an alternate coloring palette for the color palette 1140 generated from the color palette API 1120 and/or the media generation diffusion model 1130. Based on the updated version of the colored image 1150, the coloring page generation system 106 generates an updated version of the preview image 1160.

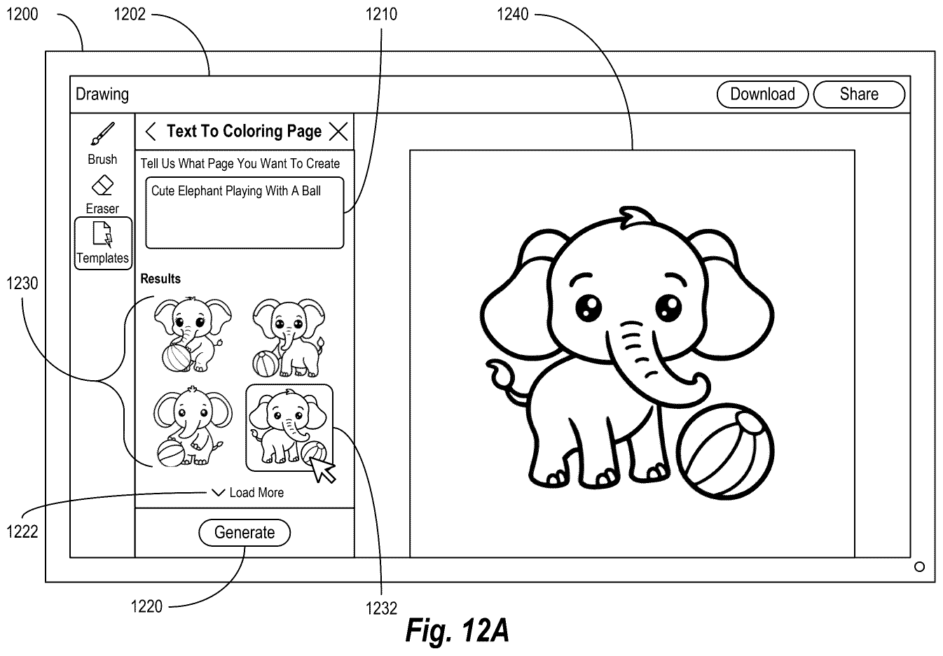

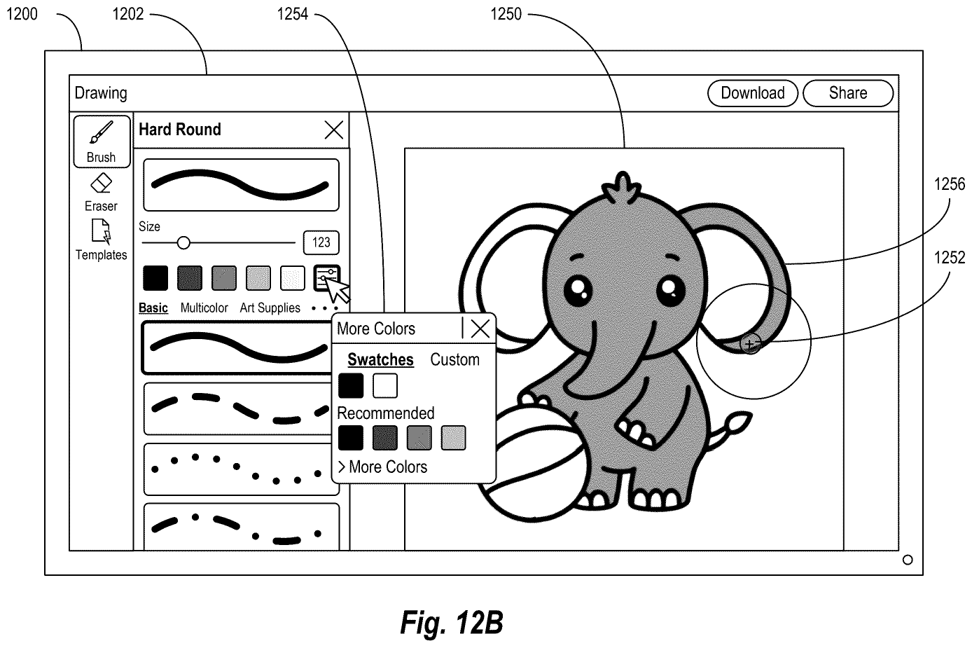

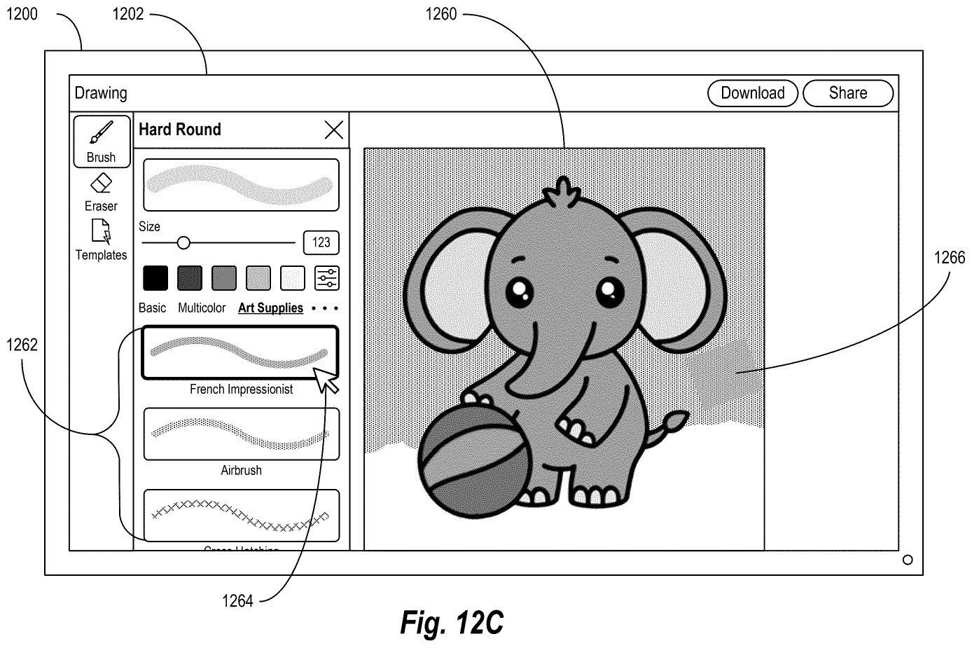

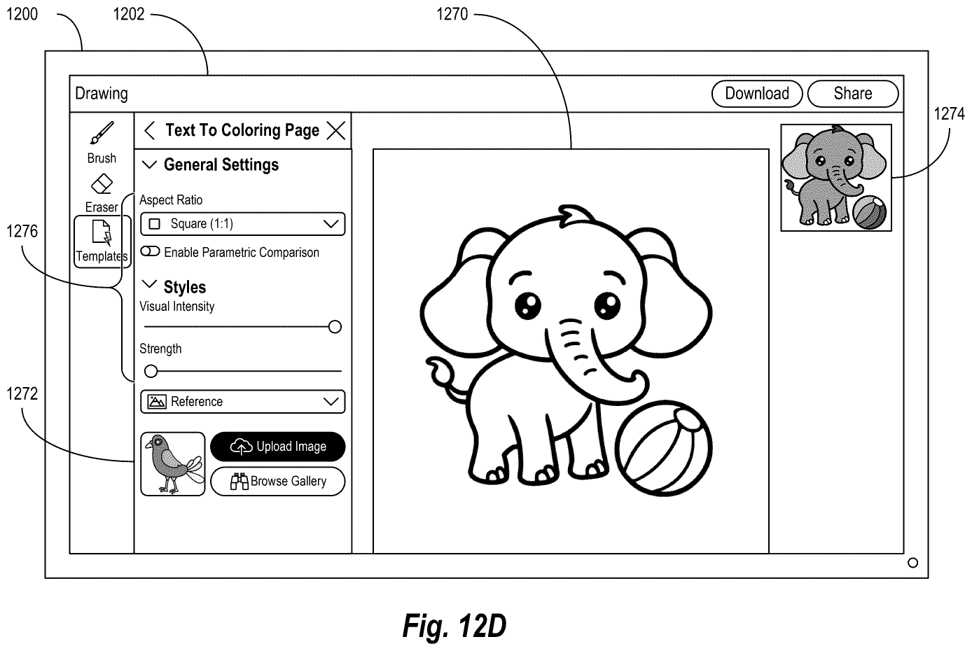

Based on a text prompt, the coloring page generation system 106 generates a coloring page as described in relation to FIGS. 1-11. Furthermore, in one or more embodiments, the coloring page generation system 106 provides a user interface for interacting with coloring pages, viewing preview images, drawing along the edges of elements, filling coloring pages with colors from the color palette, and/or controlling strokes to stay within the designated outlines of the coloring page. FIGS. 12A-12D illustrate examples of utilizing a graphical user interface to generate coloring pages utilizing the coloring page generation system in accordance with one or more embodiments.

As shown in FIG. 12A, the coloring page generation system 106 provides the graphical user interface 1202 for display on a client device 1200. As shown, the graphical user interface 1202 includes options for generating a coloring page 1240 from a text prompt 1210. The coloring page generation system 106 receives an indication to generate the coloring page 1240 based on the text prompt 1210 via the generate button 1220. As shown, the coloring page generation system 106 generates a coloring page portraying elements from the text prompt 1210 as described in relation to FIGS. 1-11. In particular the coloring page generation system 106 generates, utilizing the media generation diffusion model and from the image generation prompt, the coloring page 1240 utilizing continuous outlines which separate fillable regions to portray the elements described in the text prompt 1210.

In one or more embodiments, the coloring page generation system 106 provides a selection of coloring pages on the client device 1200. For example, the coloring page generation system 106 generates one or more coloring page options 1230. In some cases, based on an interaction with the coloring page option 1232, the coloring page generation system 106 selects a coloring page for the coloring page 1240. As also shown, the coloring page generation system 106 generates additional coloring page options based on an interaction. with the load more option 1222.

As shown in FIG. 12B, the coloring page generation system 106 provides a paint-inside capability for the coloring page 1250. For example, the coloring page generation system 106 provides options within the graphical user interface 1202 to fill fillable areas of the coloring page 1250 based on a single user device interaction. In one or more embodiments, the coloring page generation system 106 provides a selection of colors for coloring the coloring page 1250. In addition, the coloring page generation system 106 provides a selection of colors based on the color palette 1254 selected as describe above in relation to FIG. 11. In some cases, the coloring page generation system 106 provides a selection of colors for the color palette 1254 based on user preferences.

To illustrate, based on a user interaction with the fillable area 1252, the coloring page generation system 106 fills the fillable area 1252 with a color. For example, the coloring page generation system 106 receives a user interaction to select a color from a color palette 1254. Furthermore, the coloring page generation system 106 receives a user interaction to color the fillable area 1252 (e.g., a click on the fillable area 1252). Based on the user interaction with the fillable area 1252, the coloring page generation system 106 fills the fillable area 1252 with the selected color from a color palette 1254. Notably, the coloring page generation system 106 automatically fills the entire area of the fillable area 1252 with the color while preventing the color from spilling outside the continuous outline 1256.

As shown in FIG. 12C, in one or more embodiments, the coloring page generation system 106 provides additional options for the paint-inside capability for the coloring page 1260. For example, the coloring page generation system 106 provides a selection of fills 1262 for filling the fillable areas. As shown, the coloring page generation system 106 receives a user interaction 1264 to select a fill from a selection of fills 1262. Based on a user interaction with the fillable area 1266, the coloring page generation system 106 fills the fillable area 1266 with the selected color using the selected fill. As shown, based on a user interaction with the fillable area 1252, the coloring page generation system 106 controls the strokes with the selected fill to stay within the designated outlines of the coloring page (and not overlap the elephant).

As shown in FIG. 12D, in one or more embodiments, the coloring page generation system 106 provides additional options for generating the coloring page 1270. As mentioned, the coloring page generation system 106 utilizes a media generation diffusion model to generate a coloring page depicting elements from a text prompt by replicating visual characteristics from a reference image 1272. As shown, the coloring page generation system 106 provides configurable options to customize the coloring page 1270 by selecting from options 1276 for the reference image 1272. In one or more embodiments, the options 1276 include options such as an aspect ratio, a style, a visual intensity, or an image selection for the reference image 1272. As shown, the coloring page generation system 106 generates, utilizing the media generation diffusion model, the coloring page 1270 which replicates visual characteristics from the reference image 1272.

As further shown, the coloring page generation system 106 generates, utilizing a coloring page preview model, the preview image 1274 by filling the fillable regions of the coloring page 1270 with colors. In some cases, based on a user device interaction, the coloring page generation system 106 recolors the preview image 1274 with a new color palette. For example, the coloring page generation system 106 generates the preview image 1274 as described in relation to FIG. 11. To elaborate, by utilizing vibrant colors in the reference image 1272, the coloring page generation system 106 guides the media generation diffusion model to use similar hues in the preview image 1274, creating a lively and dynamic reference for the coloring page 1270. In turn, the coloring page generation system 106 provides, for display by the client device 1200, the coloring page 1270 and the preview image 1274.

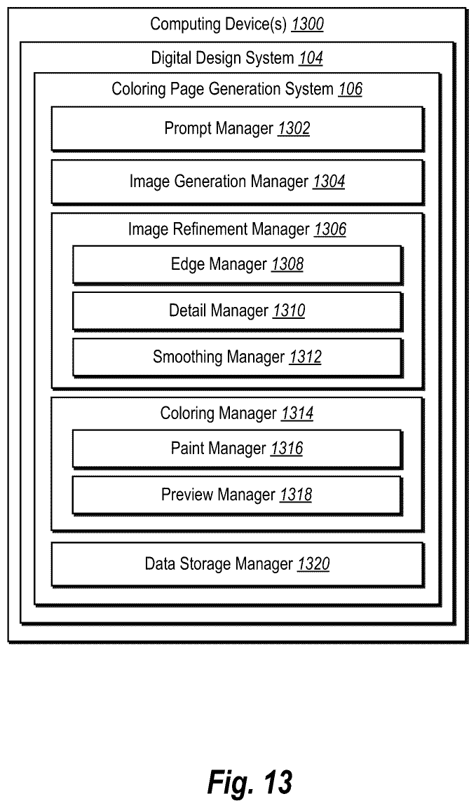

Turning now to FIG. 13, additional detail will now be provided regarding various components and capabilities of the coloring page generation system 106. In particular, FIG. 13 illustrates the coloring page generation system 106 implemented by the computing device 1300 (e.g., the server device(s) 102 and/or one of the client device(s) 110 discussed above with reference to FIG. 1). Additionally, the coloring page generation system 106 is also part of the digital design system 104. As shown in FIG. 13, the coloring page generation system 106 includes, but is not limited to, a prompt manager 1302, an image generation manager 1304, an image refinement manager 1306, a coloring manager 1314, and a data storage manager 1320.

As just mentioned, and as illustrated in FIG. 13, the coloring page generation system 106 includes the prompt manager 1302. In one or more embodiments, the prompt manager 1302 manages generating a refined prompt which includes instructions engineered to guide the media generation diffusion model to generate a preliminary coloring page based on replicating visual characteristics from a reference image. In one or more embodiments, the prompt manager 1302 generates an image generation prompt from a text prompt received via an interaction with a user device specifying one or more elements for a coloring page. In certain embodiments, the prompt manager 1302 generates the image generation prompt by combining the text prompt, a reference image, and prompt keywords.

As further shown in FIG. 13, the coloring page generation system 106 includes the image generation manager 1304. In one or more embodiments, the image generation manager 1304 utilizes a generative neural network designed to create the preliminary coloring page guided by the image generation prompt generated by the prompt manager 1302. In particular, the coloring page generation system 106 utilizes the image generation manager 1304 to generate a preliminary coloring image that is optimized for coloring. In some cases, the image generation manager 1304 generates a preliminary coloring page that incorporates particular qualities of a digital coloring page by emphasizing clear, continuous outlines and simplified shapes, making the image more suitable for coloring. In one or more embodiments, the image generation manager 1304 generates the preliminary coloring page to mimic traditional coloring books with black outlines, no gaps, clear edges, big/distinct coloring spaces, harmonious composition, and/or moderate details.

As also shown in FIG. 13, the coloring page generation system 106 utilizes the image refinement manager 1306 to generate a coloring page from the preliminary coloring page. For example, the image refinement manager 1306 generates a two-tone image from the preliminary coloring page, removing details from the two-tone image based on a detail threshold, and utilizing anti-aliasing to enhance the outlines within the two-tone image to generate the coloring page.

In some cases, the image refinement manager 1306 utilizes the edge manager 1308 convert the preliminary coloring page into a two-tone image. For example, the edge manager 1308 converts the preliminary coloring page into dark and light regions (e.g., a black and white image). In some cases, the edge manager 1308 defines the elements within the preliminary coloring page by converting dark areas to continuous outlines (e.g., borders or edges) and light areas into fillable regions (or background). In this way, the edge manager 1308 uses a two-tone transformation to generate a two-tone image with distinct outlines and fillable areas.

Furthermore, in some cases, the image refinement manager 1306 utilizes the detail manager 1310 to refine the outlines generated by the edge manager 1308. Utilizing the detail manager 1310, the image refinement manager 1306 removes unnecessary details from the continuous outlines to simplify the coloring page. In some embodiments, the detail manager 1310 removes unnecessary details that are not part of the continuous outlines (e.g., excess marks or unconnected lines). For example, the detail manager 1310 identifies and removes narrow fillable regions and borders that are only a few pixels wide. By eliminating these extraneous details, the detail manager 1310 simplifies the two-tone image while retaining the continuous outlines that portray elements of the coloring image.

Additionally, in some cases, the image refinement manager 1306 utilizes the smoothing manager 1312 to perform anti-aliasing and further enhance the two-tone image and generate the coloring page. For example, the smoothing manager 1312 smooths the continuous outlines of the two-tone image, eliminating jaggedness in the continuous outlines. In some cases, the smoothing manager 1312 utilizes anti-aliasing to generate continuous outlines that are crisp and clear for the coloring page 250. In this way, the smoothing manager 1312 generates the coloring page as a high-quality coloring template with clean continuous outlines (that portray elements from the text prompt) and distinct fillable regions which is optimized for coloring.

As shown in FIG. 13, the coloring page generation system 106 utilizes the coloring manager 1314. The coloring manager 1314 provides a graphical user interface for a user device to generate coloring pages utilizing the coloring page generation system. Based on a text prompt, the coloring manager 1314 generates a coloring page. In particular the coloring manager 1314 generates, from the image generation prompt, the coloring page for display on the user device utilizing continuous outlines which separate fillable regions to portray the elements from the text prompt.

In some cases, the coloring manager 1314 utilizes the paint manager 1316 to provide a paint-inside capability for the coloring page within the graphical user interface. In particular, the paint manager 1316 provides the graphical user interface which provides the ability to fill fillable areas of the coloring page based on a single user device interaction. In some cases, based on a user interaction with a fillable area, the paint manager 1316 fills the entire portion of the fillable area with a selected color. For example, the paint manager 1316 automatically fills the entire area of the fillable area with the color while preventing the color from spilling outside the continuous outline surrounding the fillable area.

In some cases, the coloring manager 1314 utilizes the preview manager 1318 to generate a preview image from the coloring page utilizing a coloring page preview model. For example, the preview manager 1318 generates a preview image that serves as a reference by providing a pre-colored example based on a selected or generated color palette. In some cases, the preview manager 1318 utilizes the coloring page preview model to generate the preview image by filling the fillable regions of the coloring page with colors selected from the color palette.

Additionally, as shown, the coloring page generation system 106 includes the data storage manager 1320. In particular, the data storage manager 1320 (implemented by one or more memory devices) stores the digital design documents, including the visual text objects and the coloring pages. The data storage manager 1320 facilitates the use of the digital design documents by the coloring page generation system 106.

Each of the components 1302-1320 of the coloring page generation system 106 includes software, hardware, or both. For example, the components 1302-1320 include one or more instructions stored on a computer-readable storage medium and executable by processors of one or more computing devices, such as a client device or server device. When executed by the one or more processors, the computer-executable instructions of the coloring page generation system 106 causes the computing device(s) to perform the methods described herein. Alternatively, the components 1302-1320 include hardware, such as a special-purpose processing device to perform a certain function or group of functions. Alternatively, the components 1302-1320 of the coloring page generation system 106 include a combination of computer-executable instructions and hardware.

Furthermore, the components 1302-1320 of the coloring page generation system 106 are implemented as one or more operating systems, as one or more stand-alone applications, as one or more modules of an application, as one or more plug-ins, as one or more library functions or functions called by other applications, and/or as a cloud-computing model. Thus, in some embodiments, the components 1302-1320 of the coloring page generation system 106 are implemented as a stand-alone application, such as a desktop or mobile application. Furthermore, in some embodiments, the components 1302-1320 of the coloring page generation system 106 are implemented as one or more web-based applications hosted on a remote server. Alternatively, or additionally, the components 1302-1320 of the coloring page generation system 106 are implemented in a suite of mobile device applications or “apps.” For example, in one or more embodiments, the coloring page generation system 106 comprises or operates in connection with digital software applications such as: ADOBE® EXPRESS®, ADOBE® PHOTOSHOP®, ADOBE® PHOTOSHOP® ELEMENTS, ADOBE® ILLUSTRATOR®, ADOBE® INCOPY, ADOBE® INDESIGN®, and ADOBE® DESIGNER, ADOBE® FIREFLY®, ADOBE® FRESCO®. The foregoing are either registered trademarks or trademarks of Adobe Inc. in the United States and/or other countries.

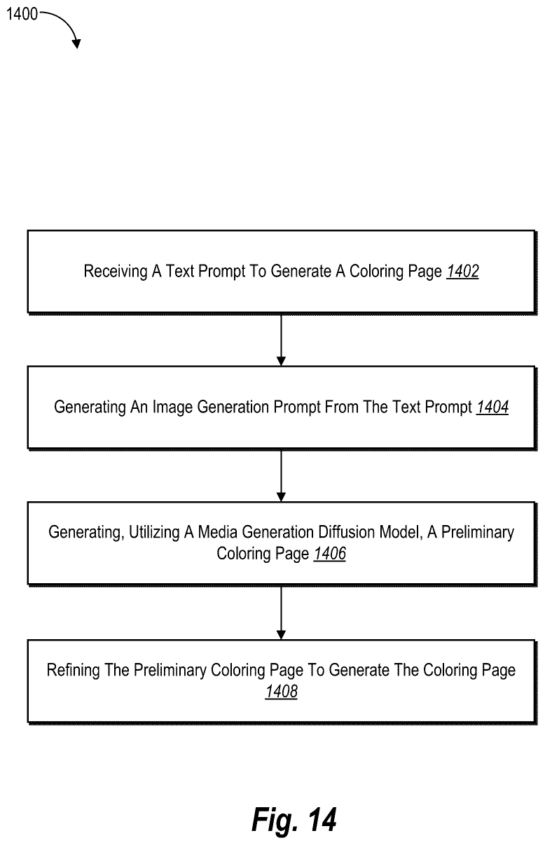

FIGS. 1-13, the corresponding text, and the examples provide a number of different methods, systems, devices, and non-transitory computer-readable media of the coloring page generation system 106. In addition to the foregoing, one or more embodiments are also described in terms of flowcharts comprising acts for accomplishing a particular result, as shown in FIG. 14. In some embodiments, the acts shown in FIG. 14 are performed in connection with more or fewer acts. Further, the acts may be performed in differing orders. Additionally, in various embodiments, the acts described herein are repeated or performed in parallel with one another or parallel with different instances of the same or similar acts. A non-transitory computer-readable medium includes instructions that, when executed by one or more processors, cause a computing device to perform the acts of FIG. 14. In some embodiments, a system is configured to perform the acts of FIG. 14. Alternatively, the acts of FIG. 14 are performed as part of a computer-implemented method.

FIG. 14 illustrates a flowchart of a series of acts 1400 for modifying a digital document with a coloring page generation system 106 in accordance with one or more embodiments. While FIG. 14 illustrates acts according to one embodiment, alternative embodiments omit, add to, reorder, and/or modify any acts shown in FIG. 14.

FIG. 14 illustrates an example series of acts 1400 for utilizing a coloring page generation system 106 to generate a blended text object from visual text objects within a digital design document. In particular, in certain embodiments, the series of acts 1400 includes an act 1402 of receiving a text prompt to generate a coloring page. Specifically, in one or more embodiments, the act 1402 includes receiving, via an interaction with a user device, a text prompt to generate a coloring page portraying one or more elements. In particular, in certain embodiments, the series of acts 1400 includes an act 1404 of generating an image generation prompt from the text prompt. As illustrated, in some embodiments, the series of acts 1400 also includes an act 1406 of generating, utilizing a media generation diffusion model, a preliminary coloring page. In particular, in one or more embodiments, the act 1406 includes generating, utilizing a media generation diffusion model, from the image generation prompt, a preliminary coloring page depicting the one or more elements. In certain embodiments, the series of acts 1400 also includes an act 1408 of refining the preliminary coloring page to generate the coloring page.

In addition (or in the alternative) to the acts described above, in certain embodiments, the coloring page generation system series of acts 1400 also includes generating the image generation prompt comprises combining the text prompt, a reference image, and prompt keywords. In some embodiments, the series of acts 1400 also includes generating, utilizing the media generation diffusion model, the preliminary coloring page depicting the one or more elements comprises conditioning the media generation diffusion model with a reference image to cause the preliminary coloring page to include visual characteristics from the reference image.

Moreover, in one or more embodiments, the coloring page generation system 106 series of acts 1400 includes refining the preliminary coloring page comprises converting the preliminary coloring page to a two-tone image by generating continuous outlines based on dark regions of the preliminary coloring page. Further still, in some embodiments, the coloring page generation system 106 series of acts 1400 includes refining the preliminary coloring page comprises converting the preliminary coloring page to a two-tone image by generating fillable regions based on light regions of the preliminary coloring page. Furthermore, in one or more embodiments, the coloring page generation system series of acts 1400 includes determining median color values for pixels within the two-tone image based on colors of adjacent pixels and assigning the median color values to the pixels.

Moreover, one or more embodiments, the series of acts 1400 includes refining the preliminary coloring page further comprises applying anti-aliasing to smooth edges of the continuous outlines within the two-tone image. Further still, in one or more embodiments, the series of acts 1400 includes selecting a color palette for a preview image. Moreover, in one or more embodiments, the series of acts 1400 includes generating, utilizing a coloring page preview model, the preview image by filling regions of the coloring page with colors selected from the color palette. In certain embodiments, the series of acts 1400 further includes providing, for display by the user device, the coloring page and the preview image. Moreover, one or more embodiments, the series of acts 1400 includes selecting the color palette for the preview image comprises extracting a subset of colors from the preliminary coloring page.

Furthermore, in one or more embodiments, the series of acts 1400 includes receiving, via an interaction with a user device, a text prompt to generate a coloring page portraying one or more elements. Moreover, in one or more embodiments, the series of acts 1400 includes generating, utilizing a media generation diffusion model, a preliminary coloring page representing the one or more elements based on an image generation prompt comprising the text prompt, a reference image, and prompt keywords.

In one or more embodiments, the series of acts 1400 includes refining the preliminary coloring page to generate the coloring page by generating a two-tone image comprising continuous outlines and fillable regions. Further still, in one or more embodiments, the series of acts 1400 includes refining the preliminary coloring page to generate the coloring page by removing portions of the continuous outlines within the two-tone image based on a detail threshold. In one or more embodiments, the series of acts 1400 further includes refining the preliminary coloring page to generate the coloring page by generating the coloring page by applying anti-aliasing to smooth the continuous outlines within the two-tone image.

In addition, in one or more embodiments, the series of acts 1400 includes generating the image generation prompt by selecting the prompt keywords that guide the media generation diffusion model to generate the preliminary coloring page utilizing the continuous outlines to separate the fillable regions into coloring spaces. Furthermore, in one or more embodiments, the series of acts 1400 includes refining the preliminary coloring page comprises generating the continuous outlines based on dark regions of the preliminary coloring page. In addition, in one or more embodiments, the series of acts 1400 includes refining the preliminary coloring page comprises generating the fillable regions based on light regions of the preliminary coloring page. Moreover, in one or more embodiments, the series of acts 1400 includes determining the continuous outlines and the fillable regions of the preliminary coloring page based on a comparison of pixels within the two-tone image to a luma threshold.

In one or more embodiments, the series of acts 1400 includes assigning median color values to pixels within the two-tone image based on colors of adjacent pixels. Furthermore, in one or more embodiments, the series of acts 1400 includes selecting a color palette for a preview image by extracting a subset of colors from the preliminary coloring page. In some embodiments, the series of acts 1400 also includes generating, utilizing a coloring page preview model, a preview image by filling the fillable regions of the coloring page with colors selected from the color palette. Moreover, in one or more embodiments, the coloring page generation system 106 series of acts 1400 includes providing, for display by the user device, the coloring page and the preview image.

Further still, in some embodiments, the coloring page generation system 106 series of acts 1400 includes generating the image generation prompt comprises combining the text prompt, a reference image, and prompt keywords. Furthermore, in one or more embodiments, the coloring page generation system series of acts 1400 includes generating, utilizing the media generation diffusion model, the preliminary coloring page depicting the one or more elements comprises conditioning the media generation diffusion model with a reference image to cause the preliminary coloring page to include visual characteristics from the reference image.

Moreover, one or more embodiments, the series of acts 1400 includes refining the preliminary coloring page by converting the preliminary coloring page to a two-tone image with continuous outlines and fillable regions. Further still, in one or more embodiments, the series of acts 1400 includes assigning median color values to pixels within the two-tone image. Moreover, in one or more embodiments, the series of acts 1400 includes applying anti-aliasing to edges of the continuous outlines within the two-tone image. In certain embodiments, the series of acts 1400 further includes generating, utilizing a coloring page preview model, a preview image by filling fillable regions of the coloring page with colors. Moreover, one or more embodiments, the series of acts 1400 includes providing, for display by the user device, the coloring page and the preview image.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

### System: Image Generation System Apparatus

FIG. 15 shows an example of the image generation system apparatus 1500 according to aspects of the present disclosure. The image generation system apparatus 1500 may include an example of, or aspects of, the guided diffusion model described with reference to FIG. 4 and the U-Net described with reference to FIG. 5. In some embodiments, the image generation system apparatus 1500 includes processor unit 1505, memory unit 1510, the media generation diffusion model 1515, I/O module 1520, and training component 1525. Training component 1525 updates parameters of the media generation diffusion model 1515 stored in the memory unit 1510. In some examples, the training component 1525 is located outside the image generation system apparatus 1500.

The processor unit 1505 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, the processor unit 1505 is configured to operate a memory array using a memory controller. In other cases, a memory controller is integrated into the processor unit 1505. In some cases, the processor unit 1505 is configured to execute computer-readable instructions stored in the memory unit 1510 to perform various functions. In some aspects, the processor unit 1505 includes special purpose components for modem processing, baseband processing, digital signal processing, or transmission processing. According to some aspects, the processor unit 1505 comprises one or more processors described with reference to FIG. 15.

The memory unit 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of the processor unit 1505 to perform various functions described herein.

In some cases, the memory unit 1510 includes a basic input/output system (BIOS) that controls basic hardware or software operations, such as an interaction with peripheral components or devices. In some cases, the memory unit 1510 includes a memory controller that operates memory cells of the memory unit 1510. For example, the memory controller may include a row decoder, column decoder, or both. In some cases, memory cells within the memory unit 1510 store information in the form of a logical state. According to some aspects, the memory unit 1510 is an example of the memory unit 1510 described with reference to FIG. 15.

According to some aspects, the image generation system apparatus 1500 uses one or more processors of the processor unit 1505 to execute instructions stored in memory unit 1510 to perform functions described herein. For example, the image generation system apparatus 1500 may execute instructions to generate an image generation prompt. In some cases, the image generation system apparatus 1500 may execute instructions to cause a media generation diffusion model to generate a preliminary coloring page. In some cases, the image generation system apparatus 1500 may execute instructions to cause an image refinement model to generate a coloring page. In some cases, the image generation system apparatus 1500 may execute instructions to cause a coloring page preview model to generate and/or display a preview image for a coloring page.

The memory unit 1510 may include the media generation diffusion model 1515 trained to receive, via an interaction with a user device, a text prompt to generate a coloring page portraying one or more elements and generate an image generation prompt from the text prompt. Furthermore, the memory unit 1510 may include the media generation diffusion model 1515 trained to generate, utilizing a media generation diffusion model, from the image generation prompt, a preliminary coloring page depicting elements from a text prompt. In some cases, the memory unit 1510 may include the media generation diffusion model 1515 trained to refine the preliminary coloring page to generate the coloring page. For example, after training, the media generation diffusion model 1515 may perform inferencing operations as described with reference to FIGS. 6 and 7 to generate a preliminary coloring page based on an image generation prompt.

In some embodiments, the media generation diffusion model 1515 is an Artificial neural network (ANN) such as the guided diffusion model described with reference to FIG. 4 and the U-Net described with reference to FIG. 5. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the media generation diffusion model 1515 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1525 may train the media generation diffusion model 1515. For example, parameters of the media generation diffusion model 1515 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 8 and 9). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the media generation diffusion model 1515 can be used to make predictions on new, unseen data (i.e., during inference).

I/O module 1520 receives inputs from and transmits outputs of the image generation system apparatus 1500 to other devices or users. For example, I/O module 1520 receives inputs for the media generation diffusion model 1515 and transmits outputs of the media generation diffusion model 1515. According to some aspects, I/O module 1520 is an example of the I/O interfaces 1608 described with reference to FIG. 16.

FIG. 16 illustrates a block diagram of an example computing device 1600 that may be configured to perform one or more of the processes described above. One will appreciate that one or more computing devices, such as the computing device 1600 may represent the computing devices described above (e.g., server device(s) 102, client device(s) 110, and computing device 1600). In one or more embodiments, the computing device 1600 may be a mobile device (e.g., a mobile telephone, a smartphone, a PDA, a tablet, a laptop, a camera, a tracker, a watch, a wearable device, etc.). In some embodiments, the computing device 1600 may be a non-mobile device (e.g., a desktop computer or another type of client device). Further, the computing device 1600 may be a server device that includes cloud-based processing and storage capabilities.

As shown in FIG. 16, the computing device 1600 can include one or more processor(s) 1602, memory 1604, a storage device 1606, input/output interfaces 1608 (or “I/O interfaces 1608”), and a communication interface 1610, which may be communicatively coupled by way of a communication infrastructure (e.g., bus 1612). While the computing device 1600 is shown in FIG. 16, the components illustrated in FIG. 16 are not intended to be limiting. Additional or alternative components may be used in other embodiments. Furthermore, in certain embodiments, the computing device 1600 includes fewer components than those shown in FIG. 16. Components of the computing device 1600 shown in FIG. 16 will now be described in additional detail.

In particular embodiments, the processor(s) 1602 includes hardware for executing instructions, such as those making up a computer program. As an example, and not by way of limitation, to execute instructions, the processor(s) 1602 may retrieve (or fetch) the instructions from an internal register, an internal cache, memory 1604, or a storage device 1606 and decode and execute them.

The computing device 1600 includes memory 1604, which is coupled to the processor(s) 1602. The memory 1604 may be used for storing data, metadata, and programs for execution by the processor(s). The memory 1604 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1604 may be internal or distributed memory.

The computing device 1600 includes a storage device 1606 includes storage for storing data or instructions. As an example, and not by way of limitation, the storage device 1606 can include a non-transitory storage medium described above. The storage device 1606 may include a hard disk drive (HDD), flash memory, a Universal Serial Bus (USB) drive or a combination these or other storage devices.

As shown, the computing device 1600 includes one or more I/O interfaces 1608, which are provided to allow a user to provide input to (such as user strokes), receive output from, and otherwise transfer data to and from the computing device 1600. These I/O interfaces 1608 may include a mouse, keypad or a keyboard, a touch screen, camera, optical scanner, network interface, modem, other known I/O devices or a combination of such I/O interfaces 1608. The touch screen may be activated with a stylus or a finger.

The I/O interfaces 1608 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1608 are configured to provide graphical data to a display for presentation to a user. The graphical data may be representative of one or more graphical user interfaces and/or any other graphical content as may serve a particular implementation.

The computing device 1600 can further include a communication interface 1610. The communication interface 1610 can include hardware, software, or both. The communication interface 1610 provides one or more interfaces for communication (such as, for example, packet-based communication) between the computing device and one or more other computing devices or one or more networks. As an example, and not by way of limitation, communication interface 1610 may include a network interface controller (NIC) or network adapter for communicating with an Ethernet or other wire-based network or a wireless NIC (WNIC) or wireless adapter for communicating with a wireless network, such as a WI-FI. The computing device 1600 can further include a bus 1612. The bus 1612 can include hardware, software, or both that connects components of computing device 1600 to each other.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
receiving, via an interaction with a user device, a text prompt to generate a coloring page portraying one or more elements;
generating an image generation prompt from the text prompt;
generating, utilizing a media generation diffusion model, from the image generation prompt, a preliminary coloring page depicting the one or more elements; and
refining the preliminary coloring page to generate the coloring page.

2. The computer-implemented method of claim 1, further comprising generating the image generation prompt by combining the text prompt, a reference image, and prompt keywords.

3. The computer-implemented method of claim 1, further comprising generating, utilizing the media generation diffusion model, a preliminary coloring page depicting the one or more elements by replicating visual characteristics from a reference image.

4. The computer-implemented method of claim 1, further comprising refining the preliminary coloring page by:
refining the preliminary coloring page by converting the preliminary coloring page to a two-tone image, wherein generating the two-tone image comprises:
continuous outlines based on dark regions of the preliminary coloring page; and
fillable regions based on light regions of the preliminary coloring page.

5. The computer-implemented method of claim 4, further comprising refining the preliminary coloring page by removing portions of the continuous outlines within the two-tone image by discarding pixels in regions that do not satisfy a median color for a threshold width.

6. The computer-implemented method of claim 4, further comprising refining the preliminary coloring page by applying anti-aliasing to smooth the continuous outlines within the two-tone image.

7. The computer-implemented method of claim 1, further comprising:
selecting a color palette for a preview image,
generating, utilizing a coloring page preview model, a preview image utilizing colors selected from the color palette; and
providing, for display by the user device, the coloring page and the preview image.

8. The computer-implemented method of claim 7, further comprising selecting a color palette for the preview image by extracting a subset of colors from the preliminary coloring page.

9. A system comprising:
one or more memory devices; and
one or more processors coupled to the one or more memory devices that cause the system to perform operations comprising:
receiving, via an interaction with a user device, a text prompt to generate a coloring page portraying one or more elements;
generating, utilizing a media generation diffusion model, a preliminary coloring page representing the one or more elements based on an image generation prompt comprising the text prompt, a reference image, and prompt keywords; and
refining the preliminary coloring page to generate the coloring page by:
generating a two-tone image comprising continuous outlines and fillable regions;
removing portions of the continuous outlines within the two-tone image based on a detail threshold; and
generating the coloring page by applying anti-aliasing to smooth the continuous outlines within the two-tone image.

10. The system of claim 9, further comprising generating the prompt keywords to cause the media generation diffusion model to generate the preliminary coloring page by replicating visual characteristics from the reference image utilizing the continuous outlines to separate the fillable regions and portray the one or more elements based on a style of the reference image.

11. The system of claim 9, further comprising:
generating the continuous outlines based on dark regions of the preliminary coloring page; and
generating the fillable regions based on light regions of the preliminary coloring page.

12. The system of claim 11, further comprising determining the continuous outlines and the fillable regions of the preliminary coloring page based on a luma threshold.

13. The system of claim 9, further comprising removing the portions of the continuous outlines within the two-tone image by discarding pixels in regions that do not satisfy a median color for a threshold width.

14. The system of claim 9, further comprising:
selecting a color palette for a preview image by extracting a subset of colors from the preliminary coloring page,
generating, utilizing a coloring page preview model, a preview image by filling the fillable regions of the coloring page with colors selected from the color palette; and
providing, for display by the user device, the coloring page and the preview image.

15. A non-transitory computer-readable medium storing instructions thereon that, when executed by at least one processor, cause the at least one processor to perform operations comprising:
receiving, via an interaction with a user device, a text prompt to generate a coloring page portraying one or more elements;
generating an image generation prompt from the text prompt;
generating, utilizing a media generation diffusion model, from the image generation prompt, a preliminary coloring page depicting the one or more elements; and
refining the preliminary coloring page to generate the coloring page.

16. The non-transitory computer-readable medium of claim 15, wherein the operations further comprise:
generating the image generation prompt by combining the text prompt, a reference image, and prompt keywords; and
generating, utilizing the media generation diffusion model, from the image generation prompt, the preliminary coloring page by replicating visual characteristics from the reference image utilizing continuous outlines which separate fillable regions to portray the one or more elements.

17. The non-transitory computer-readable medium of claim 15, wherein the operations further comprise refining the preliminary coloring page by converting the preliminary coloring page to a two-tone image comprising continuous outlines and fillable regions.

18. The non-transitory computer-readable medium of claim 15, wherein the operations further comprise removing portions of continuous outlines within the preliminary coloring page by discarding pixels in regions that do not satisfy a median color for a threshold width.

19. The non-transitory computer-readable medium of claim 15, wherein the operations further comprise applying anti-aliasing to pixels of continuous outlines within the preliminary coloring page to smooth the continuous outlines.

20. The non-transitory computer-readable medium of claim 15, wherein the operations further comprise:
generating, utilizing a coloring page preview model, a preview image by filling fillable regions of the coloring page with colors; and
providing, for display by the user device, the coloring page and the preview image.
